(19) United States
(12) Patent Application Publication
(10) Pub. No.: US 2024/0034009 A1
(43) Pub. Date: Feb. 1, 2024

(54) COMPOSITE PRODUCT, COMPOSITE PRODUCT PRODUCTION SYSTEM, COMPOSITE PRODUCT PRODUCTION PROCESS, AND SYSTEM AND METHOD FOR REDUCING VOC EMISSIONS ASSOCIATED WITH COMPOSITE PRODUCT PRODUCTION

(71) Applicant: Toray Advanced Composites USA Inc., Morgan Hill, CA (US)

(72) Inventors: Mark Jennings, Northridge, CA (US); David Wharton, Newbury Park, CA (US); Tom Smith, West Hills, CA (US); Anil Sharma, Yorba Linda, CA (US); Jinfeng Zhuge, Thousand Oaks, CA (US); Kapil Inamdar, Newbury Park, CA (US)

(73) Assignee: Toray Advanced Composites USA Inc., Morgan Hill, CA (US)

(21) Appl. No.: 18/023,987

(22) PCT Filed: Aug. 31, 2021
(86) PCT No.: PCT/US2021/048500

§ 371 Date: Feb. 28, 2023

(51) Int. Cl. B29C 70/54; B29C 70/42; B29C 37/00

(52) U.S. Cl. CPC B29C 70/542; B29C 70/42; B29C 70/545; B29C 37/006

(57) ABSTRACT

A system is provided for producing composite products including a substrate and a resin integrated with the substrate. The system includes a press located between an upstream end portion of the system, which is configured to receive the substrate into the system, and a downstream end portion of the system, which is configured to deliver the composite products from the system; a lower film supply located at the upstream end portion of the system and configured to introduce a lower film into the system and in a downstream direction toward the press; a substrate supply located at the upstream end portion of the system and configured to introduce the substrate into the system, onto the lower film, and in the downstream direction toward the press; a resin dispenser located upstream of the press and downstream of the substrate supply and configured to apply the resin to the substrate to form a resin-substrate combination; an upper film supply located downstream of the resin dispenser and configured to introduce an upper film into the system, in the downstream direction toward the press, and onto the resin-substrate combination; and a film removal station located at a downstream end portion of the system and configured to remove the lower film and the upper film from the resin-substrate combination; the press being located downstream of the upper film supply and upstream of the film removal station, the press being positioned to apply pressure to the resin-substrate combination through the upper film and the lower film when the resin-substrate combination is co-located with the press.

### CROSS-REFERENCE TO RELATED APPLICATION

This application claims priority to U.S. Provisional Application No. 63/073,284, titled “COMPOSITE PRODUCT, COMPOSITE PRODUCT PRODUCTION SYSTEM, COMPOSITE PRODUCT PRODUCTION PROCESS, AND SYSTEM AND METHOD FOR REDUCING VOC EMISSIONS ASSOCIATED WITH COMPOSITE PRODUCT PRODUCTION”, filed Sep. 1, 2020, the contents of which are incorporated herein by reference in its entirety for all purposes.

### FIELD OF THE INVENTION

The present invention relates to a process for manufacturing reinforced composite products such as composite panels, the process providing at least one of improved control, reduced emissions, and reduced costs.

### BACKGROUND OF THE INVENTION

Prior art manufacturing methods of composite parts include traditional processes involving Resin Transfer Molding (RTM) and Vacuum Assisted RTM (VARTM). Although these processes may be suitable in particular applications, there remains a need for improved processes and systems for manufacturing reinforced composite products such as panels that provide at least one of improved control, reduced emissions, and reduced costs.

### SUMMARY OF THE INVENTION

Panel Production Assembly (Equipment Assembly and Subassemblies)

According to one aspect of the invention, a system is provided for producing composite products including a substrate and a resin integrated with the substrate, the system including: a press located between an upstream end portion of the system, which is configured to receive the substrate into the system, and a downstream end portion of the system, which is configured to deliver the composite products from the system; a lower film supply located at the upstream end portion of the system and configured to introduce a lower film into the system and in a downstream direction toward the press; a substrate supply located at the upstream end portion of the system and configured to introduce the substrate into the system, onto the lower film, and in the downstream direction toward the press; a resin dispenser located upstream of the press and downstream of the substrate supply and configured to apply the resin to the substrate to form a resin-substrate combination; an upper film supply located downstream of the resin dispenser and configured to introduce an upper film into the system, in the downstream direction toward the press, and onto the resin-substrate combination; and a film removal station located at a downstream end portion of the system and configured to remove the lower film and the upper film from the resin-substrate combination; the press being located downstream of the upper film supply and upstream of the film removal station, the press being positioned to apply pressure to the resin-substrate combination through the upper film and the lower film when the resin-substrate combination is co-located with the press.

Die Assembly

According to another aspect of the invention, a die is provided for use with a press for forming composite products including a substrate and a resin integrated with the substrate, the die including: a lower film configured for movement relative to the press in a downstream direction extending from an upstream end of the press toward a downstream end of the press, the lower film having an upper surface positioned to support a combination of the substrate and the resin, the lower film having a continuous length selected to extend beyond the upstream end of the press in an upstream direction and beyond the downstream end of the press in the downstream direction; an upper film configured for movement relative to the press in the downstream direction extending from the upstream end of the press toward the downstream end of the press, the upper film having a lower surface positioned to contact the combination of the substrate and the resin, the upper film also having a continuous length selected to extend beyond the upstream end of the press in the upstream direction and beyond the downstream end of the press in the downstream direction; and a seal formed by contact between the upper surface of the lower film and the lower surface of the upper film, the seal being positioned to at least partially surround the substrate, the seal extending along portions of the continuous lengths of the lower film and the upper film, and the seal extending lateral to the continuous lengths of the lower film and the upper film; the lower film, the upper film, and the seal together defining a die interior configured to enclose the combination of the substrate and the resin.

Panel Production Process (Steps for Panel Production)

According to yet another aspect of the invention, a process is provided for producing composite products including a substrate and a resin integrated with the substrate, the process including: supplying a lower film to introduce the lower film in a downstream direction; supplying a substrate to introduce the substrate in the downstream direction and onto the lower film; dispensing a resin to apply the resin to the substrate to form a resin-substrate combination; supplying an upper film to introduce an upper film onto the resin-substrate combination; applying pressure to the resin-substrate combination through the upper film and the lower film; and removing the lower film and the upper film from the resin-substrate combination.

VOC Capture Assembly

According to still another aspect of the invention, a system is provided for capturing Volatile Organic Compound (VOCs) during the production of composite products including a substrate and a resin integrated with the substrate, the system including: a resin dispenser positioned to apply the resin to the substrate to form a resin-substrate combination, the resin dispenser including an enclosure into which the substrate can be introduced when the enclosure is open, the enclosure being configured to contain VOCs emitted in the enclosure when the enclosure is closed; a filter coupled to receive VOCs from the enclosure of the resin dispenser; and an exhaust configured to reduce pressure within the enclosure and positioned to purge the VOCs from the enclosure and into the filter, the exhaust being operable when the enclosure is open to allow the substrate to enter the enclosure and to allow the resin-substrate combination to exit the enclosure.

VOC Capture Process

According to another aspect of the invention, a process is provided for capturing VOCs while producing composite products including a substrate and a resin integrated with the substrate to form a resin-substrate combination, the process including: opening an upstream gate of an enclosure; actuating an exhaust to reduce pressure within the enclosure when the upstream gate of the enclosure is open; receiving the substrate in the enclosure through the upstream gate of the enclosure; closing the upstream gate of the enclosure; applying the resin to the substrate to form the resin-substrate combination in the enclosure; and exhausting VOCs from the enclosure and into a filter.

Reinforced Composite Product

According to yet another aspect of the invention, a reinforced composite product is provided including: a substrate; and a resin integrated with the substrate; the reinforced composite product having an exterior surface characterized by uniformity of at least one of color, weave pattern, and surface veil appearance.

Reinforced Composite Product

According to another embodiment of the invention, a reinforced composite product is provided including: a substrate; and a resin integrated with the substrate; the reinforced composite product characterized by uniformity of at least one of thickness, fiber content, thickness after secondary pressing, noise generation in ultrasonic C-scan, fiber content, and cross-section.

According to another aspect of the invention, a Resin Content Uniformity Index of the reinforced composite product is 16 or greater, a Resin Content Covariance of the reinforced composite product is 5% or less, and/or a Resin Content Uniformity of the reinforced composite product is 83% or greater.

According to another aspect of the invention, a Thickness Uniformity Index of the reinforced composite product is 8 or greater, a Thickness Covariance of the reinforced composite product is 7% or less, and/or a Thickness Uniformity of the reinforced composite product is 61% or greater.

### BRIEF DESCRIPTION OF THE DRAWINGS

The foregoing summary and the following description will be better appreciated and understood in conjunction with the non-limiting examples illustrated in the attached drawing figures, of which:

FIG. 1 schematically illustrates a process pathway for manufacturing reinforced composite panels in accordance with an exemplary embodiment of the invention;

FIG. 2 is a perspective view of an embodiment of a production assembly for producing composite products such as panels including a substrate and a resin integrated into the substrate;

FIG. 3A is a side view of an embodiment of a system for producing composite products including a substrate and a resin integrated into the substrate;

FIG. 3B is a side view of the system of FIG. 3A, showing a process pathway for producing composite products including a substrate and a resin integrated into the substrate;

FIG. 3C is a schematic side view of the system of FIG. 3A;

FIG. 3D is a side view of a variation of the system of FIG. 3C, showing a process pathway for producing composite products including a substrate and a resin integrated into the substrate;

FIG. 4A is a top view of the system of FIG. 3A;

FIG. 4B is a top view of a variation of the system of FIG. 3A, showing a system for capturing Volatile Organic Compound (VOCs) during the production of composite products including a substrate and a resin integrated into the substrate;

FIG. 4C is a top view of the system of FIG. 3C.

FIG. 5A is a perspective view of an embodiment of a press of the system of FIG. 3C;

FIG. 5B is a schematic side view of the press of FIG. 5A;

FIG. 6 is a side view of an embodiment of a lower film supply of the system of FIG. 3C;

FIG. 7 is a side view of an embodiment of an upper film supply of the system of FIG. 3C;

FIG. 8 is a side view of an embodiment of a substrate supply of the system of FIG. 3C;

FIG. 9A is a top view of an embodiment of a resin dispenser in accordance with an aspect of the invention;

FIG. 9B is a perspective view of embodiments of a nozzle having an eye configuration or a square configuration;

FIG. 9C is a top view of the resin dispenser of FIG. 9A, showing application of the resin in a predetermined pattern of x-y coordinates based at least in part on a shape of the substrate;

FIG. 9D illustrates a pattern of x-y coordinates of FIG. 9C, in accordance with another embodiment of the invention, the dimensions shown being variable from those indicated and being only illustrative of one possible embodiment;

FIG. 10 is a side view of an embodiment of a film removal station in accordance with an aspect of the invention;

FIG. 11 is a side view of a die in accordance with an embodiment of the invention;

FIG. 12A is a flow diagram summarizing the process pathway for producing composite products including a substrate and a resin integrated with the substrate;

FIG. 12B is a flow diagram illustrating a process pathway in accordance with an exemplary embodiment of the invention;

FIG. 12C is a flow diagram illustrating the process pathway of FIG. 12A in accordance with an exemplary embodiment of the invention, showing the start of a production mode for infusion and movement with the press OFF;

FIG. 12D is a flow diagram illustrating the process pathway of FIG. 12A in accordance with an exemplary embodiment of the invention, showing a full production mode for infusion and movement with the press ON;

FIG. 13 is a flow diagram illustrating the system for capturing Volatile Organic Compound (VOCs) in accordance with an embodiment of the invention;

FIG. 14 is a schematic view of an embodiment of a system for capturing Volatile Organic Compound (VOCs);

FIG. 15 is a flow diagram showing a process pathway for capturing VOCs while producing composite products including a substrate and a resin integrated with the substrate to form a resin-substrate combination;

FIG. 16 is a reinforced composite product in accordance with an exemplary embodiment of the invention, having a length L, a width W, and a thickness T.

FIG. 17 depicts a system for a mass-balance experiment process performed to determine the reduction of VOC emissions while producing composite products in accordance with an exemplary embodiment of the invention.

FIG. 18 depicts a bar graph showing the results of the experiment completed using the system of FIG. 17.

FIGS. 19A-19B depict scanning electron microscopy images (100× magnification in color) of cross-sectional samples from a composite panel produced in accordance with a first process (FIG. 19A) and a composite panel produced in accordance with a second, improved process according to aspects of the present invention.

FIGS. 20A-20B depict scanning electron microscopy images (100× magnification) of cross-sectional samples from a composite panel produced in accordance with the first process and a composite panel produced in accordance with the improved process.

FIGS. 21A-21B depict scanning electron microscopy images (200× magnification in color) of cross-sectional samples from a composite panel produced in accordance with the first process and a composite panel produced in accordance with the improved process.

FIGS. 22A-22B depict scanning electron microscopy images (200× magnification in color) of cross-sectional samples from a composite panel produced in accordance with the first process and a composite panel produced in accordance with the improved process.

FIG. 23 depicts a flow chart illustrating the first process.

FIG. 24 depicts locations of samples obtained for measuring the thickness of a composite panel.

FIG. 25 depicts locations of samples obtained for measuring the resin content of a composite panel.

### DETAILED DESCRIPTION OF EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

Additionally, various forms and embodiments of the invention are illustrated in the figures. It will be appreciated that the combination and arrangement of some or all features of any of the embodiments with other embodiments is specifically contemplated herein. Accordingly, this detailed disclosure expressly includes the specific embodiments illustrated herein, combinations and sub-combinations of features of the illustrated embodiments, and variations of the illustrated embodiments.

Panel Production System

It has been recognized that some processes, including for example those employing resin injection concepts to impregnate substrates with resins for the production of composite materials, can result in a greater risk of fabric pattern distortion. For example, a non-uniform surface appearance may result from the radial flow path of polymer resin across a substrate in a resin injection process, which may generate different levels of resin distribution across the composite product. The radial resin flow front in a resin injection process can also result in excess waste of the resin. Additionally, the radial resin flow in a resin injection process can result in prolonged substrate impregnation times in situations where the substrate material may be non-circular. For example, it would take additional time for the resin to reach and impregnate the corners of a square or rectangular shaped substrate in a resin injection process. In addition, such manufacturing methods tend to use metallic tool dies, which can make the laminate handling and curing process cumbersome.

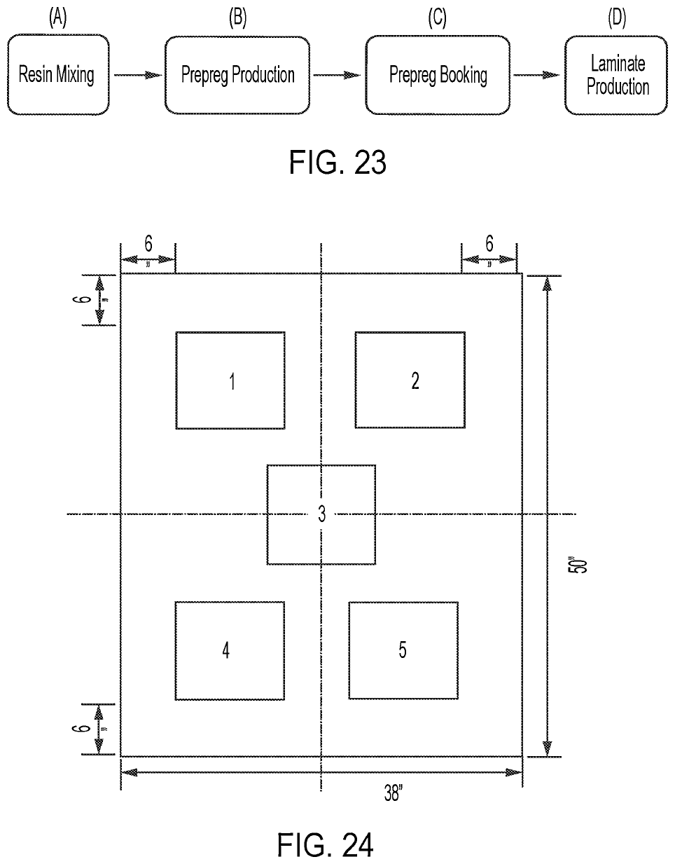

In contrast to a resin injection process, some processes may improve upon resin injection processes include steps of wrapping, stacking, and cooling of pre-pressed sections of material for subsequent unwrapping and pressing. Referring to FIG. 23, for example, a first process may be generally described as having four steps: step (A) resin mixing, step (B) prepreg production, step (C) prepreg booking, and step (D) laminate production.

In step (A) of the first process, ingredients of the resin system are weighed and formulations of the ingredients are determined and prepared. Though the duration of mixing can vary, the resin mixing can take about 3 hours or more. Thereafter, the mixed resin is stored in a freezer for future use (perhaps the next day).

In step (B), the prepared resin formulation is applied to a desired substrate. Specifically, the resin is held in a dispensing trough and then applied with a doctor blade. Further, resin coated substrates are separately packaged in a layer of plastic film for storage and placed into a freezer to allow for the polymer to impregnate the substrates without kicking off an exothermic reaction. This step may take 24 hours or more and includes removing the resin from the freezer, applying the resin to the substrate, and storing the resin coated substrate in the freezer (in some examples, a minimum of 16 hours may be required and this can take up to 3 days).

In step (C), the resin-impregnated substrates are removed from the freezer after a predetermined time that can last from a few hours to ten hours. The external plastic film layer is then removed from each substrate. A new layer of plastic film is added to either side of the resin impregnated substrate. Additionally, more layers of release film or paper, fabric with special coating, such as polytetrafluoroethylene (PTFE), etc. might be added optionally if or as necessary or beneficial. Multiple such layers are created, staked and prepared for curing/cross-linking of the resin system to produce a final product, such as a composite laminate. This step may vary in duration but may take about 2 hours to complete.

In step (D), the prepared layers of the resin impregnated substrate are cured in a static press or a combination of two or more static presses. At the end of the press cycle, the materials are removed from the press. This is followed by removal of the plastic film and any additional layer or layers of materials that may have been used in step (C). A cured composite laminated is therefore yielded. This step may vary in duration but may take about 2 hours to complete.

As will be discussed below in greater detail, an improved process according to aspects of this invention can further improve upon the first process. For example, the improved process can be less labor intensive, requiring less physical manpower, number of process steps, and number of operators in the production of panels/laminates. Additionally, the improved process can result in a reduced amount of wasted raw materials, thus increasing the overall process yield. Furthermore, the improved process eliminates the need for special freezer or refrigeration storage of materials, and also, offers an overall set-up with a significantly reduced operational footprint.

In order to further improve upon such systems, this invention also makes it possible to produce fiber or fabric or substrate reinforced composite panels impregnated with polymer or resin systems in a semi-continuous process. The semi-continuous process can provide significantly improved control, a reduction in Volatile Organic Compounds (VOCs) emitted from the polymer or resin system, as well as other benefits.

Referring generally to the figures, the system 100 is one embodiment of an improved system for impregnating substrates with resin and makes it possible to avoid use of the resin injection concept. By doing so, the system 100 reduces or eliminates the radial flow path of the polymer across the substrate as well as the resulting non-uniform surface appearance caused by different levels of resin distribution across the composite laminate or fabric pattern distortion. The system 100 also makes it possible to avoid use of the metallic tool dies that can make the laminate curing process cumbersome. As an alternative to the tool die concept, the improved system 100 makes it possible to use a set of disposable films as a die according to one aspect of the invention.

The improved process (such as the embodiment of system 100) also includes improvements to the first process described above. For example, the improved process can be less labor intensive, requiring less physical manpower, a reduced number of process steps, and a reduced number of operators in the production of panels/laminates. Also, the improved process can be semi-continuous or continuous. Additionally, the improved process can result in a reduced amount of wasted raw materials, thus increasing the overall process yield. Other benefits of the improved process are described elsewhere herein.

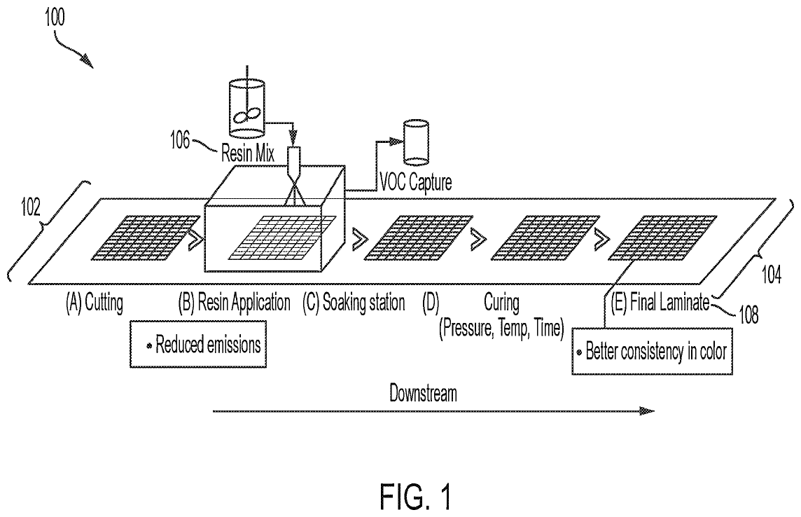

While the process pathway of FIG. 1 illustrates certain steps performed in a particular order, it should be understood that the embodiments of the present invention may be practiced by adding one or more steps to the processes, omitting steps within the processes and/or altering the order in which one or more steps are performed.

Referring generally to the figures, a system 100 for producing composite products including a substrate, such as substrate 14, and a resin, such as resin 106, integrated with the substrate 14, is disclosed. A lower film supply, such as lower film supply 12, is located at an upstream end portion 102 of the system 100, which is configured to receive the substrate 14 into the system 100. The lower film supply 12 is configured to introduce a lower film, such as lower film 316, into the system 100 and in a downstream direction toward a downstream end portion 104 of the system, which is configured to deliver the composite products, such as final laminates 108, from the system 100. A substrate supply, such as substrate supply 13, is located at the upstream end portion 102 of the system 100 and configured to introduce the substrate 14 into the system 100 and onto the lower film 316 and in the downstream direction toward a downstream end portion 104 of the system.

In step (A) illustrated in FIG. 1, the substrate 14 can be cut at a substrate indexing station located at an upstream end portion 102 of the system.

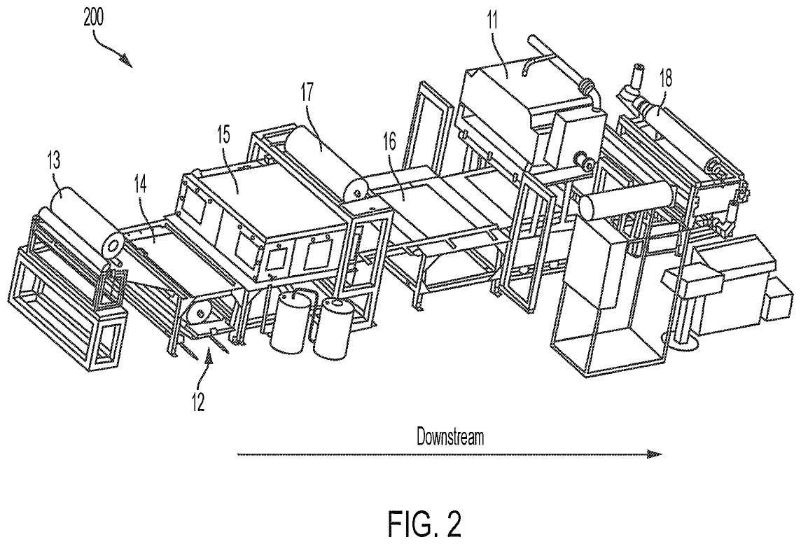

In step (B), a resin dispenser, such as resin dispenser 15 (FIG. 2), is located downstream of the substrate supply 13 and configured to apply the resin 106 to the substrate 14 to form a resin-substrate combination, such as combination 16. Further, an upper film supply, such as upper film supply 17, is located downstream of the resin dispenser 15 and configured to introduce an upper film 317 into the system 100 onto the resin-substrate combination 16. As indicated in FIG. 1 by the boxed phrase “reduced emissions,” VOC emissions can be reduced or eliminated by providing seals on gates of the resin dispenser 15. Additionally, reduction or elimination of VOC emissions is not limited in this step or in this location. For example, reduction or elimination of VOC emissions can be achieved at multiple locations along the assembly line where VOC emissions may escape. Specifically, VOC emissions can be reduced or eliminated by keeping a release liner closed at its edges while the resin-substrate combination 16 moves from a form of enclosure in which resin is applied, such as resin dispenser 15, to the press 11. In another embodiment, VOC emissions can be reduced or eliminated by sealing the press 11 to retain heat and resin inside the press 11 and deliver a more fully polymerized product, such as laminate 108.

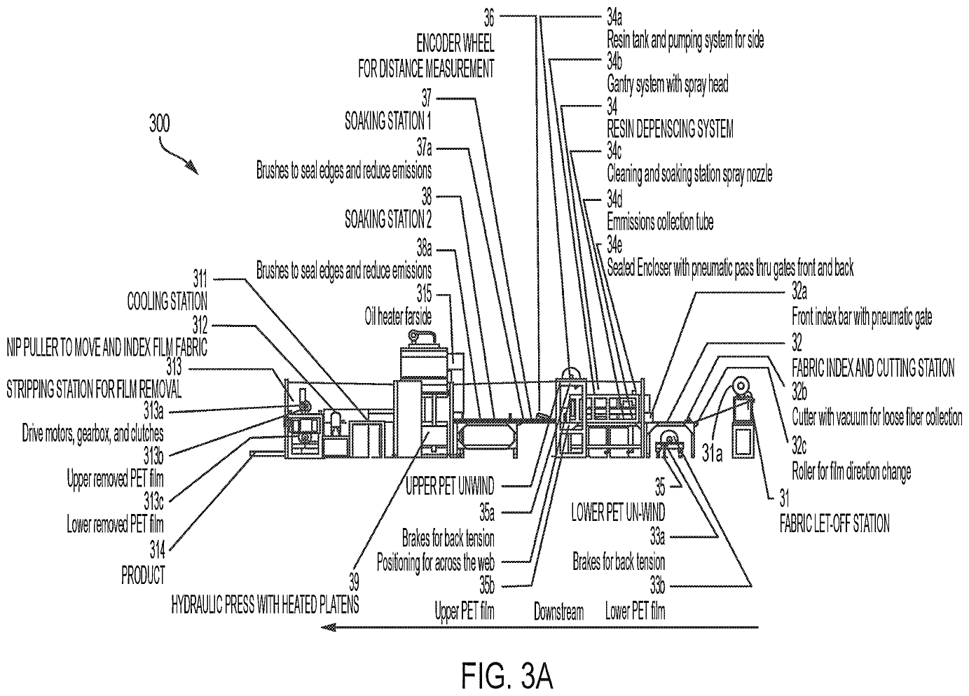

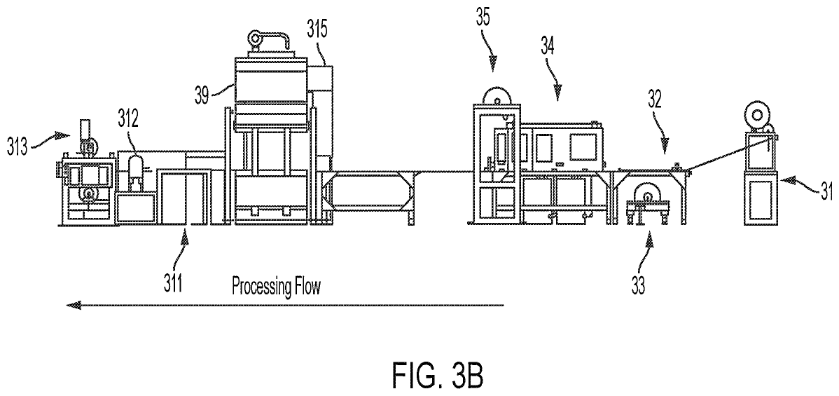

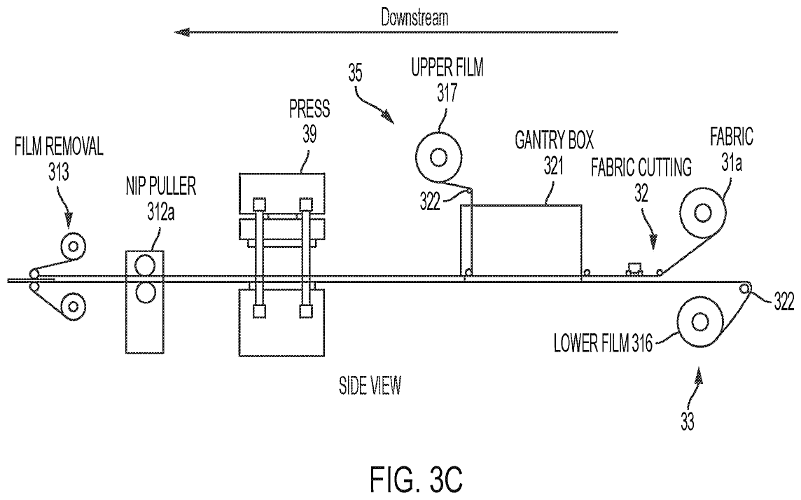

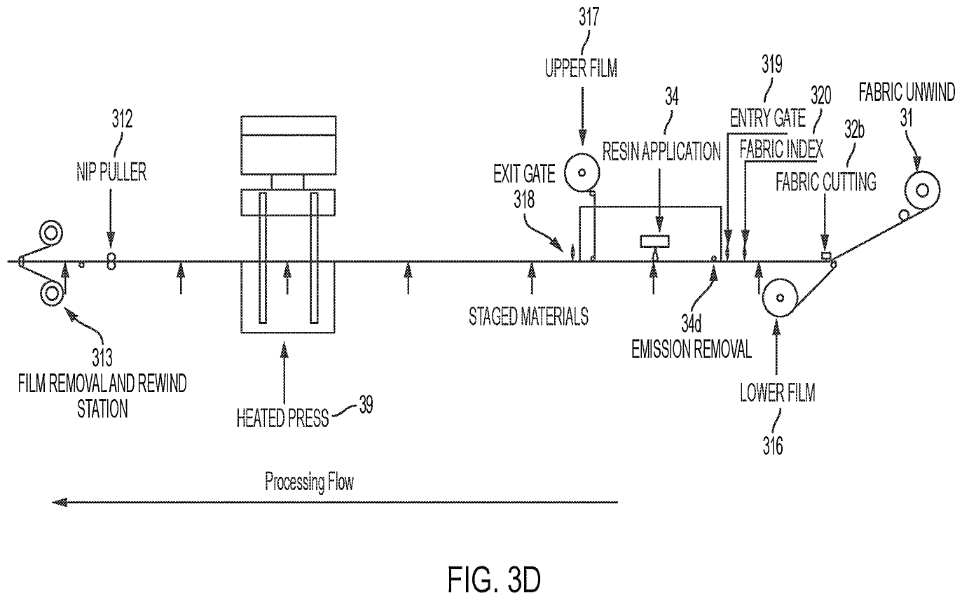

In step (C), as the resin-substrate combination 16 exits the resin dispenser 15 and moves in a downstream direction to a next station, such as a soaking station 1 (item 37 in FIG. 3A) and a soaking station 2 (item 38), each configured to seal edges of the upper film 317 to edges of the lower film 316, thereby reducing VOC emissions.

In step (D), the resin-substrate combination 16 moves in a downstream direction toward a press, such as press 11, the press being positioned to apply pressure to the resin-substrate combination through the upper film 317 and the lower film 316 when the resin-substrate combination 16 is co-located with the press 11. According to one embodiment of the invention, the curing process comprises a resin temperature and viscosity control step, which is performed for crosslinking control and to build up molecular weight. A temperature and viscosity control step may be configured to occur at one or more soaking stations having a preheating station, which is configured to initiate or accelerate polymer reaction. In yet another embodiment, the curing process comprises one or more of the soaking stations applying a vacuum to remove any undesired trapped air, contaminants, and/or particulates from the resin-substrate combination 16.

In step (E), a film removal station, such as film removal station 18, is located at a downstream end portion 104 of the system and configured to remove the lower film 33b and the upper film 35b from the resin-substrate combination 16. At a downstream end portion 104 of the system, reinforced composite product 108 is delivered from the system 100. In one example, reinforced composite product 108 comprises a substrate, such as substrate 14, and a resin 106 integrated with the substrate 14, and has an exterior surface characterized by uniformity of at least one of color, weave pattern, and surface veil appearance. In another example, reinforced composite product 108 comprises a substrate, such as substrate 14, and a resin 106 integrated with the substrate 14, and has an exterior surface characterized by uniformity of at least one of thickness, fiber content, resin content, thickness after secondary pressing, noise generation in ultrasonic C-scan, and cross-section.

As explained in greater detail elsewhere, the improved process according to embodiments of this invention makes it possible to achieve, for example, improved consistency in color, reduced surface deformities, and improved thickness uniformity, among other improved properties. Accordingly, the process makes it possible to produce panels that can be utilized for downstream processing into final products and components with greater quality and predictability.

### Panel Production Assembly

Generally, the improved panel production assembly 200 disclosed herein uses two films creating a die, a continuous or semi-continuous transport system, and a press to produce composite panels. Embodiments of the panel production assembly are illustrated in the figures and described below.

In one embodiment, as illustrated by FIGS. 1 and 3A-3D, a system 300 is provided for producing a composite product 314 including a substrate 31a and a resin 106 integrated with or impregnated into the substrate 31a. System 300 comprises a substrate supply, such as fabric let-off station 31, located at the upstream end portion 102 of the system and configured to introduce the substrate 31a into the system and in the downstream direction toward a press 39.

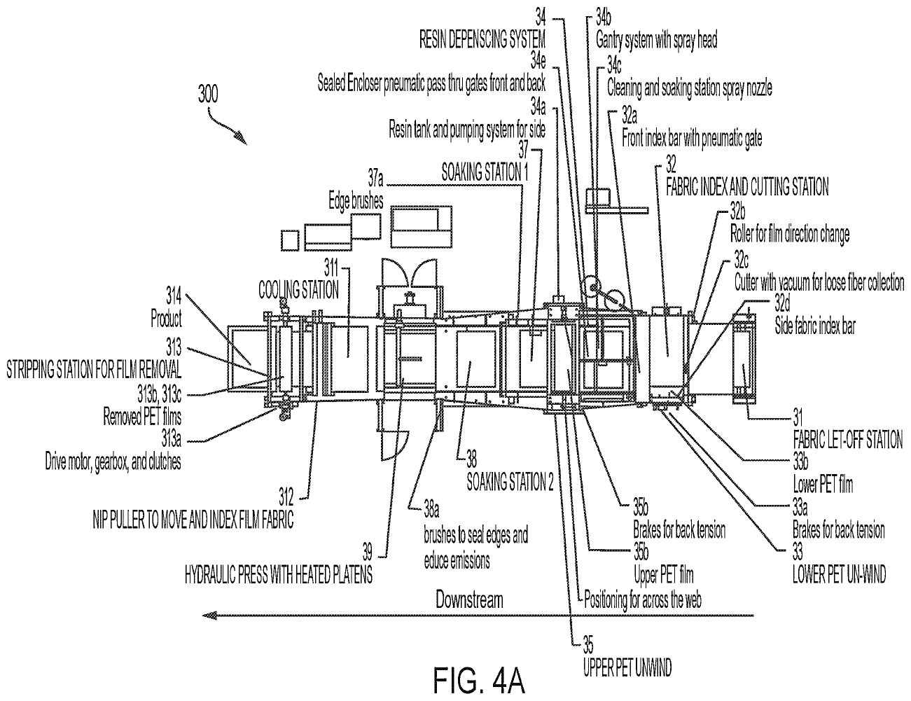

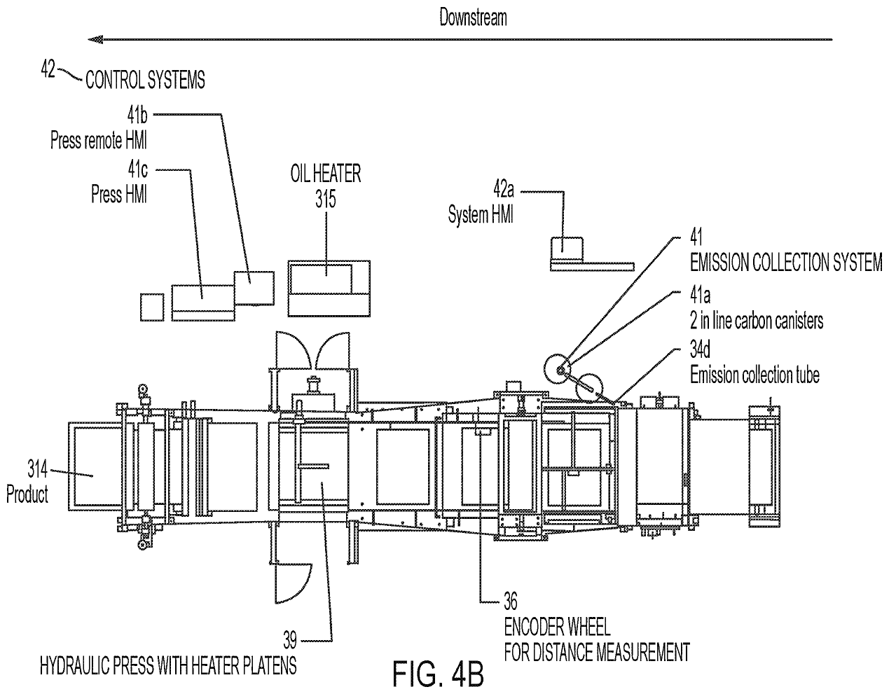

The substrate 31a can be cut from a larger substrate at a substrate indexing station, such as a fabric index and cutting station 32, located at an upstream end portion 102 of the system and configured to index a position 320 of the substrate relative to a position of the lower film 316. The fabric index and cutting station 32 comprises a cutter 32b having a vacuum to collect loose fiber from substrate 31a and a roller 32c configured to facilitate movement of the substrate 31a along a continuous or semi-continuous transport system. As seen in FIG. 4A, the fabric index and cutting station includes a side index bar 32d and a front index bar 32a having an upstream gate, such as entry gate 319, that opens to allow the substrate to enter a resin dispenser, such as resin dispensing system 34.

A lower film supply, such as a lower polyethylene terephthalate (PET) un-wind 33, is located at the upstream end portion 102 of the system and configured to introduce a lower film 316 into the system and in a downstream direction toward the press 39. The lower PET un-wind 33 supplies lower film, such as lower film 33b including polyethylene terephthalate. The lower PET-unwind 33 also includes brakes 33a to supply back tension.

The substrate 31a is disposed onto the lower film and in the downstream direction toward an enclosure, such as a resin dispensing system 34, which is located upstream of the press 39 and downstream of the fabric let-off station 31 and configured to apply the resin 106 to the substrate 31a to form a resin-substrate combination 16. The resin dispensing system 34 includes a resin reservoir, such as a resin tank 34a having a pumping system including a pump configured to advance resin 106 for application to the substrate 31a. The resin dispensing system 34 further comprises an enclosure, such as a gantry system 34b, configured to spray the resin 106 onto the substrate 31a, the enclosure including (i) a spray box 321, as seen in FIGS. 3C and 4C, (ii) a spray head, and (iii) a cleaning and soaking station 34c.

The resin dispensing system 34 further comprises an exhaust, such as emission tube 34d, which is configured to reduce pressure within resin dispensing system 34 and is positioned to purge VOCs from the resin dispensing system 34 and into a filter, such as filter 41a of FIG. 4B, which is coupled to receive VOCs from the resin dispensing system 34. The emission collection tube 34d is operable when the resin dispensing system 34 is open to allow the substrate 31a to enter the resin dispensing system 34 and to allow the resin-substrate combination 16 to exit the resin dispensing system 34.

The resin dispensing system 34 also includes a downstream gate, or exit gate 318, such as for example the pneumatic pass thru gate (back) 34e, that opens to allow the resin-substrate combination 16 to exit the resin dispensing system 34.

An upper film supply 17, such as upper PET unwind 35, is located downstream of, or aligned with, the resin dispensing system 34. The upper PET un-wind 35 supplies upper film 317, such as upper film 35b including polyethylene terephthalate. The upper PET-unwind 35 also includes brakes 35a to supply back tension.

The upper PET unwind 35 is configured to introduce an upper film 317 into the system, in a downstream direction toward an upstream gate, such as pneumatic pass thru gate (front) 34e of the resin dispensing system 34, and onto the resin-substrate combination, the upper film 317 providing a barrier against the escape of VOCs from the resin-substrate combination as the resin-substrate combination exits the downstream gate of the resin dispensing system 34. The upper film 317 can be introduced through a gate in the top of the enclosure at a location downstream of the spray head(s) applying resin to the substrate. In this configuration, the upper film 317 travels downwardly onto the surface of the resin-wetted substrate and then exits the enclosure through a downstream gate of the enclosure.

A sensor or an encoder attached, for example, to a rotating object such as a wheel is part of system automation. The encoder wheel, such as encoder wheel 36, is programmed to measure the distance of material movement in the process flow direction for ensuring consistent and accurate positioning of the material in each process step. The encoder wheel can also be programmed for dynamic behavior such that the rate of movement of the material is smooth and free of abrupt starts and stops to ensure good process flow and continuity.

The resin-substrate combination is pulled to one or more wet-out stations, such as soaking station 1 (37) and a soaking station 2 (38), each including an edge sealer including one or more brushes (37a, 38a) configured to seal edges of the upper film 317 to edges of the lower film 316, thereby reducing VOC emissions as the resin-substrate combination exits the downstream gate 34e of the resin dispensing system 34.

In one embodiment of the present invention, at least one wet-out station includes a heater, which is configured to maintain an elevated temperature of the resin-substrate combination as it moves in a downstream direction towards the press 39. Maintaining an elevated temperature of the resin-substrate combination may be achieved by means of at least one of ultraviolet light, heat lamps, or other temperature sources as would be understood by persons skilled in the art.

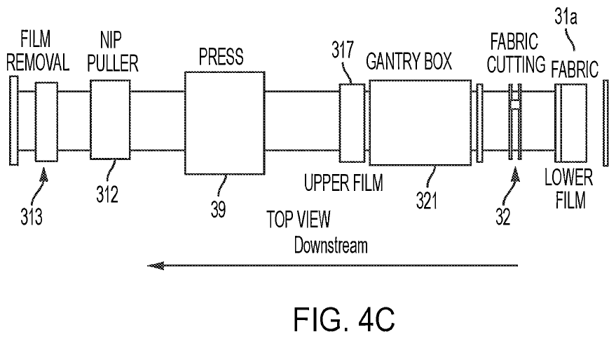

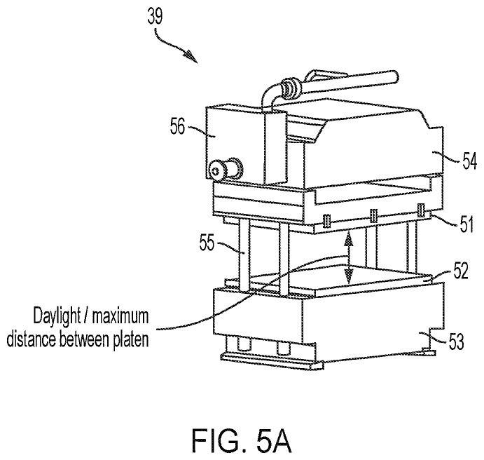

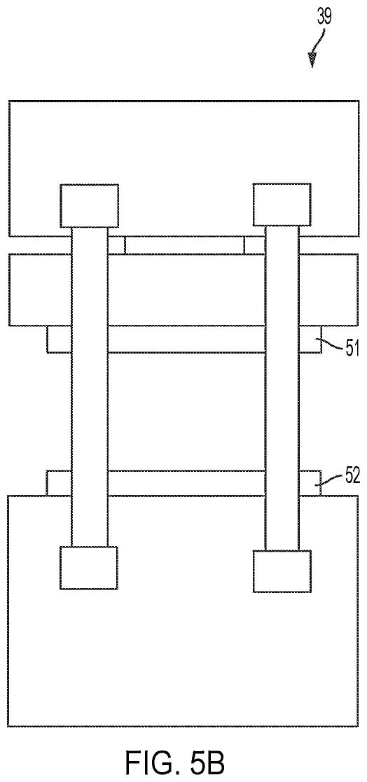

The press 39 is located downstream of the upper film supply 35 and upstream of a film removal station 18, such as stripping station 313. Furthermore, the press 39 is positioned to apply pressure to the resin-substrate combination through the upper film 317 and the lower film 316 when the resin-substrate combination is co-located with the press 39. In addition, as seen in FIGS. 5A-5B, the press 39 is optionally a hydraulic press having at least one of a top platen 51 and a bottom platen 52 that is heated.

The press 39 is configured to close on the lower film 316 and the upper film 317 with the resin-substrate combination between the lower film 316 and the upper film 317 until a seal is formed to enclose at least a portion of the lower film 316, the upper film 317, and the resin-substrate combination. When the top platen 51 and the bottom platen 52 are moved away from one another by movement of at least one of the top platen 51 and the bottom platen 52, the press 39 opens and the seal is released and the resin-substrate combination is pulled to a cooling station 311, which is located upstream from a film removal station 18, such as stripping station 313.

System 300 also includes a pulling station, such as station 312 having a nip puller 312a, configured to pull the lower film 316 and the upper film 317, with the resin-substrate combination between the lower film 316 and the upper film 317, in a downstream direction. Nip puller 312a is located downstream of the press upstream of a film removal station, such as stripping station 313. Stripping station 313 is configured to remove the lower film 316 and the upper film 317 from the resin-substrate combination. Stripping station 313 includes an unwinder, such as winder 313a, configured to roll the lower film 316 and the upper film 317 onto respective rolls (313b, 313c) of the lower film 316 and the upper film 317, the winder 313a including drive motors, a gear box, and clutches as appropriate.

At a downstream end portion 104 of the system, reinforced composite product 314 is delivered from the system 300. In one example, reinforced composite product 314 comprises a substrate, such as substrate 31a, a resin 106 integrated with the substrate 31a, and has an exterior surface characterized by uniformity of at least one of color, weave pattern, and surface veil appearance. In another example, reinforced composite product 314 comprises a substrate, such as substrate 31a, a resin 106 integrated with the substrate 31a, and has an exterior surface characterized by uniformity of at least one of thickness, fiber content, thickness after secondary pressing, noise generation in ultrasonic C-scan, resin content, and cross-section.

Press

Referring now to FIG. 2, the press 11 is located downstream of the upper film supply 17 and upstream of the film removal station 18. Furthermore, the press 11 is positioned to apply pressure to the resin-substrate combination 16 through the upper film and the lower film when the resin-substrate combination 16 is co-located with the press 11. The press 11 is configured to apply pressure to the resin-substrate in an amount suitable for a particular application. For example, press 11 can apply pressure from 0 psi to 300 psi, or preferably from 10 psi to 200 psi, or more preferably from 20 psi to 150 psi.

The press 11 is also configured to apply pressure for a pre-determined duration. For example, press 11 can be configured to apply pressure for 4 min to 60 min, preferably 5 min to 30 min, or more preferably 5 min to 10 min. In one embodiment, the press 11 is configured to apply pressure being selected as a function of time. As illustrated in FIG. 4B, process control stations such as control systems 42, are configured to control various process parameters, including press parameters such as pressure, time, and temperature. The parameters may be programmed to run in automatic or manual mode.

As seen in FIG. 5A-5B, the press 39 includes a top platen 51 and a bottom platen 52 mounted for movement relative to one another such that when the top platen 51 and the bottom platen 52 are moved toward one another by movement of at least one of the top platen 51 and the bottom platen 52, the press 39 can close on the lower film 316 and the upper film 317 with the resin-substrate combination 16 between the lower film 316 and the upper film 317 until a seal is formed to enclose at least a portion of the lower film 316, the upper film 317, and the resin-substrate combination 16. When the top platen 51 and the bottom platen 52 are moved away from one another by movement of at least one of the top platen 51 and the bottom platen 52, the press 39 opens and the seal is released.

The bottom platen 52 is mounted on a press bed 53, which is configured for movement relative to press crown 54. The press bed 53 and press crown 54 are separated by a fixed distance D defined by a plurality of vertical guide posts 55. When the top platen 51 and the bottom platen 52 are moved toward one another by movement of at least one of the top platen 51 and the bottom platen 52, the distance between top platen 51 and bottom platen 52 decreases. The press 39 further comprises an oil tank 56 configured to supply the working fluid and includes a pressure release valve.

In one embodiment, as seen in FIGS. 3A, 4A-4B, the press is a hydraulic press. Furthermore, as see in FIGS. 3A, 4A-4B, at least one of the top platen 51 and the bottom platen 52 may be heated. At least one of the top platen 51 and the bottom platen 52 may be heated, for example, to an elevated temperature from 60° F. to 400° F., preferably from 70° F. to 300° F., or more preferably from 80° F. to 250° F.

Heater

In one embodiment, as shown in FIG. 3A, the system 100 further includes a heater, such oil heater 315, configured to heat the platens (51, 52) to an elevated temperature above an ambient temperature, the elevated temperature being selected to accelerate curing or polymerization of the resin 106 of the resin-substrate combination. The elevated temperature is also selected to control the rate of reaction and molecular weight of the cross-linked polymer in the final composite. In one example, the heater 351 is configured to heat the resin-substrate combination to a temperature up to 240° F. (or greater, depending on the materials and process parameters selected). The heater 351 may be heated to a temperature from 60° F. to 400° F., preferably from 70° F. to 300° F., or more preferably from 80° F. to 250° F. In another example, the temperature is selected via process control stations such as control systems 42 of FIG. 4B.

Substrate Supply

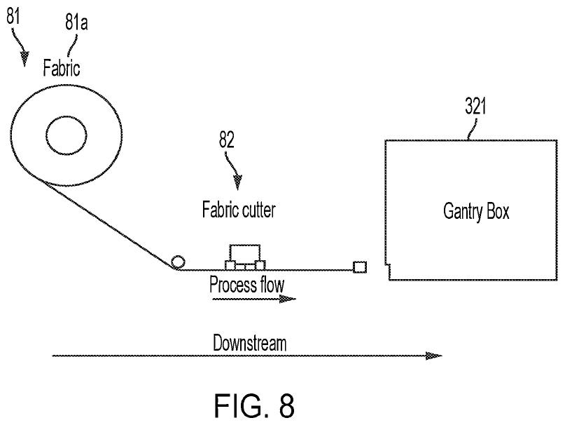

In one embodiment, as shown in FIG. 8A, a substrate supply 13, such as fabric 81, is configured to introduce substrate 31a, such as a roll of fabric 81a, into system 300 and in the downstream direction toward a resin dispenser 15 including a gantry box 321. The substrate 81a can be cut from a larger substrate at a cutting station 32, such as fabric cutter 82, located at an upstream end portion 102 of the system.

Substrate

The substrate 14 can include fibrous material, non-fibrous material, or a combination thereof. Also, the substrate 14 can include metallic material, non-metallic material, or a combination thereof. For example, the substrate 14 can include one or more of glass, carbon, ceramic, basalt, steel, and cellulosic fiber materials, and combinations thereof. Also, the substrate 14 can include one or more of continuous, discontinuous, woven, non-woven, crimped, uncrimped, uni-directional, multi-directional, porous, and non-porous materials and hybrids or combinations thereof.

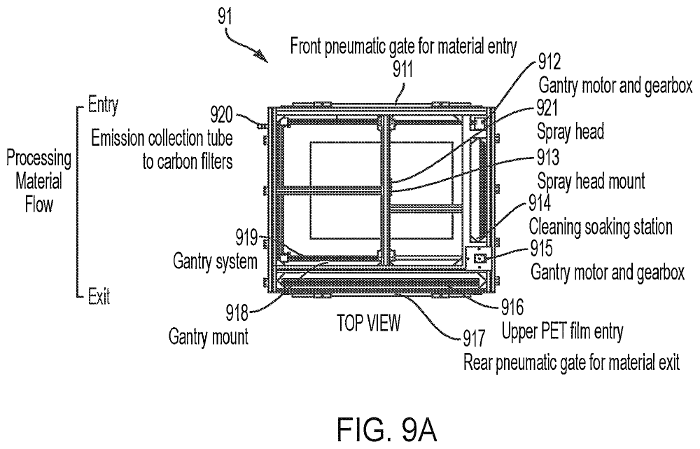

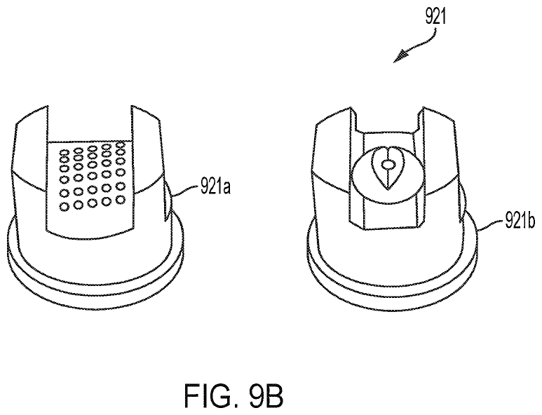

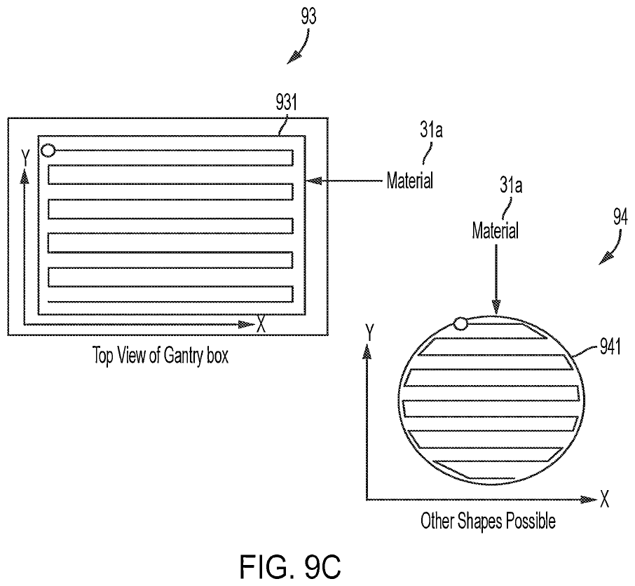

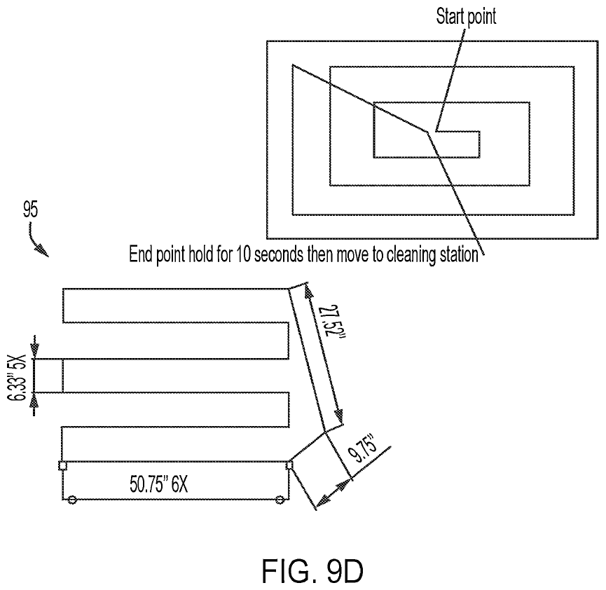

In certain embodiments, the substrate 14 is substantially planar and has an outer periphery. Further, as illustrated in FIG. 9C, the outer periphery of the substrate 14 may be a geometric shape, a predetermined shape, or an arbitrary shape. In one embodiment, for example as seen in FIG. 9C, the geometric shape may be rectangular or square.

As illustrated in FIGS. 2 and 3A, the substrate 14 can be cut from a larger substrate at an upstream end portion 102 of the system. Further, the system 100 may be configured to receive substrate 14 cut using a CNC or nesting operation. The thickness of the substrate 14 may vary. For example, the substrate 14 may have a thickness not exceeding about 5 mm, but may also be thicker or thinner.

Resin Dispenser

The resin dispenser 15 may be configured to apply resin, such as resin 106, including a thermoplastic polymer or a thermoset polymer having a viscosity up to 5000 cps. In another example, the resin dispenser 15 may be configured to apply resin 106 including a thermoplastic polymer or a thermoset polymer having a lower viscosity up to 500 cps, preferably up to 250 cps, or more preferably about 100 cps or less. The resin dispenser 15 may also be configured to apply resin 106 including a polymer, monomer, or combination thereof that can be cross-linked for polymerization. Further, the resin dispenser 15 may be configured to apply resin 106 including one or more of a color package, a reaction initiator, a reaction inhibitor, an impact modifier, a flame retardant, a lubricant, a light stabilizer, an electrical or thermal conductor additive, and an anti-oxidant.

In another embodiment, the resin dispenser 15 may be configured to apply resin 106 including a thermoplastic polymer that is dissolvable into solvent to reduce viscosity. In one example, the resin dispenser 15 may be configured to apply resin 106 including polycarbonate dissolved in a suitable solvent such as dichloromethane (DCM). As illustrated in FIGS. 9B-9D, the resin dispenser is configured to apply resin 106 by spraying. Alternatively, it will be readily understood by those persons skilled in the art that the resin 106 may also be applied via drip, dip, waterfall, bath, blade, and other application methods.

Referring now more closely to FIGS. 1 and 9A, a resin dispenser 15, such as resin dispenser 91 includes an enclosure, such as a gantry system 919, configured to spray a resin, such as resin 106, onto a substrate 14. The resin dispenser 91 has an upstream gate, or entry gate 319, such as front pneumatic gate 911, that opens to allow the substrate 14 to enter the resin dispensing system 91. The resin dispenser 91 further includes a spray nozzle, such as a spray head 921, for spraying the resin 106 onto the substrate 14. The spray head 921 is coupled to a support, such as spray head mount 913, the spray head mount 913 being movable in directions along and transverse to the downstream direction of the system.

In one example, the spray head 921 is moveable in a first direction and is configured to spray the resin 106 onto the substrate 14 in a single pass. In another example, the spray head 921 is immoveable and is configured to spray the resin 106 on the substrate 14 as the substrate 14 is moved towards the downstream direction of the system. In one embodiment, the resin dispenser 91 includes a plurality of spray heads 921 configured in a series, each spray head being configured to move in a first direction for spraying the resin 106 onto substrate 14 in at least one pass. In yet another embodiment, the resin dispenser 91 includes a plurality of spray heads 921 configured to be immoveable, such that the spray heads 921 apply resin 106 onto substrate 14 as the substrate 14 is moved towards the downstream direction of the system. Additionally, each spray head may be configured to spray a distinct formulation of resin 106 in a predetermined pattern. In other words, different resin formulations can be applied, concurrently or simultaneously, by different spray heads or spray nozzles.

An upper film supply 17 (not shown in FIGS. 1 and 9A) is located downstream of the resin dispenser 91 and is configured to introduce an upper film 317 (not shown) onto the resin-substrate combination 16. The upper film supply 17 is configured to introduce the upper film 317 into the system through an upper film gate, such as gate 916. The upper film supply 17 introduces the upper film 317 in a downstream direction toward an upstream gate, such as front pneumatic gate 911, of the resin dispensing system 91, and onto the resin-substrate combination 16. The upper film 317 provides a barrier against the escape of VOCs from the resin-substrate combination 16 as the resin-substrate combination 16 exits a downstream gate, or exit gate 318, such as rear pneumatic gate 917, of the resin dispenser 91. The rear gate 917 opens to allow the resin-substrate combination 16 to exit the resin dispenser 91. The resin dispenser 91 further comprises (i) a first gantry motor and gearbox 912, (ii) a cleaning and soaking station 914, (iii) a second gantry motor gearbox 915, and (iv) a gantry mount 918.

Finally, the resin dispenser also includes an exhaust, such as emission collection tube 920, configured to reduce pressure within gantry system 919 and positioned to purge VOCs from the gantry system 919 and into a filter, such as filter 41a of FIG. 4B, coupled to receive VOCs from the gantry system 919 of the resin dispenser 91. The emission collection tube 920 is operable when the gantry system 919 is open to allow the substrate 14 to enter the gantry system 919 and to allow the resin-substrate combination 16 to exit the gantry system 919.

As illustrated in FIGS. 3A and 9A-9B, the resin dispenser 91 may include a reservoir, such as resin tank 34a, for containing the resin 106 and a spray nozzle, such as spray head 921, coupled to receive resin 106 from the reservoir 34a and for spraying the resin 106 onto the substrate 14. Additionally, the resin dispenser 91 may include a support for the spray nozzle, such as spray head mount 913, the support being movable in directions along and transverse to the downstream direction of the system.

Referring now to FIG. 9C, the resin dispenser 91 may be configured to spray the resin 106 onto the substrate 31a in a pattern. In one example, as seen in pattern 93, a spray pattern corresponds to a perimeter, such as perimeter 931 of the substrate 31a. In another embodiment, as seen in pattern 94, a spray pattern corresponds to a shape, such as shape 941 of the substrate 31a. In another example, a spray pattern (93, 94) corresponds to the configuration of a plurality of spray nozzles, such as spray head 921, each spray head 921 being designated and connected to dispense a formulation of resin 106 onto the substrate 31a. In yet another embodiment, the pattern may be predetermined.

As illustrated in FIG. 9B, the spray nozzle, such as spray head 921, may have an eye configuration 921b or a square configuration 921a. Further, the eye configuration 921b may have opposing angled holes that create a flat pattern. Also, the eye configuration 921b may have specific angle and hole diameter configurations. In addition, it will be readily understood by those persons skilled in the art that a variety of spray tips, such as spray head 921, could be used.

As shown in FIGS. 9A-9C, the resin dispenser 91 may include a mount supporting the spray nozzle, such as spray head mount 913. Referring now to FIG. 9A, the resin dispenser 91 may further comprise a controller or control system, including a first gantry motor and gearbox 912 and second gantry motor and gearbox 915, coupled to the mount 913. As seen in FIG. 9D, the controller (912, 915) can be configured to control movement of the spray nozzle 921 in a predetermined pattern of x-y coordinates based at least in part on a shape of the substrate. It will be readily understood by those persons skilled in the art that the predetermined pattern of x-y coordinates would be defined through the use of a programming language.

Lower Film Supply

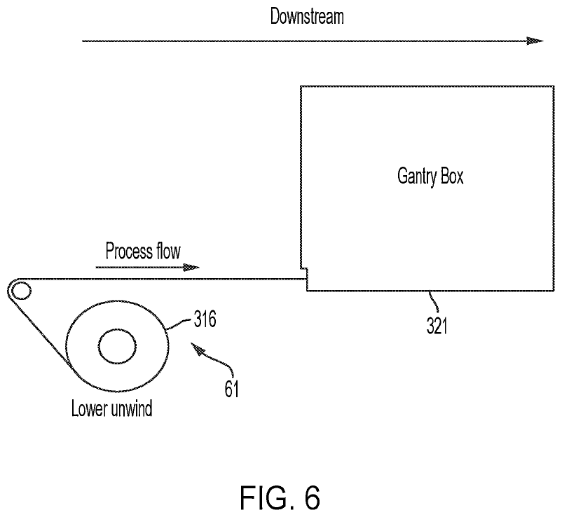

Referring now to FIG. 6A, lower film supply, such as lower unwind 61, is configured to supply a lower film 316. In one embodiment, as seen in FIG. 3A, a lower film supply 12, such as lower film 33b includes polyethylene terephthalate or polycarbonate. The lower film supply 12 may be configured to supply lower film 316 that is 0.01 inch or less in thickness. Further, the lower film supply 12 may be configured to supply a lower film 316 having a 0.075 mm nominal thickness.

Upper Film Supply

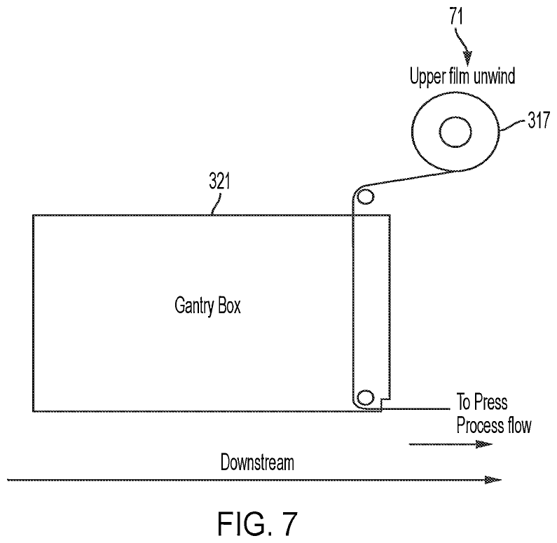

Referring now to FIG. 7A, the upper film supply, such as upper film unwind 71, is configured to supply an upper film 317. In one example, as seen in FIG. 3A, the upper film 317 includes polyethylene terephthalate or polycarbonate, such as upper film 35b. Furthermore, the upper film supply 17 may be configured to supply upper film 317 that is 0.01 inch or less in thickness. In one embodiment, the upper film supply 17 may be configured to supply upper film 317 having a 0.075 mm nominal thickness.

Referring now to FIG. 3C, a lower film supply, such as lower film supply 33, and an upper film supply, such as upper film supply 35, include an unwinder, such as unwinder 322, configured to supply the lower film 316 and the upper film 317 from respective rolls (33, 35) of the lower film 316 and the upper film 317. For example, a fabric roll or combination of rolls can be unwound from a roll and cut into finite sections.

Film Removal Station

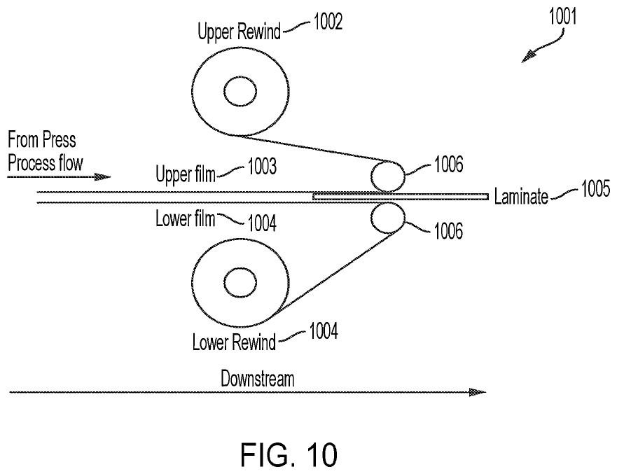

In one embodiment, as seen in FIG. 10A, the film removal station, such as stripping station 313, includes a winder, such as winders 1006, configured to roll the lower film, such as lower film 1004, and the upper film, such as upper film 1003, onto respective rolls of the lower film, such as lower rewind 1004, and the upper film, such as upper rewind 1002. The film removal station is configured to remove the lower film 1004 and the upper film 1003 from the resin-substrate combination.

At a downstream end portion 104 of the system, a reinforced composite product, such as laminate 1005, is delivered from the system. In one example, reinforced composite product 1005 has an exterior surface characterized by uniformity of at least one of color, weave pattern, and surface veil appearance. In another example, reinforced composite product 1005 has an exterior surface characterized by uniformity of at least one of thickness, fiber content, thickness after secondary pressing, noise generation in ultrasonic C-scan, resin content, and cross-section.

Pulling Station

In yet another embodiment, as seen in FIGS. 3A-3C, the system 300 includes a pulling station, such as station 312, configured to pull the lower film 316 and the upper film 317, with the resin-substrate combination 16 between the lower film 316 and the upper film 317, in a downstream direction. In one example, the pulling station 312 is located downstream of the press 39. In another example, the pulling station 312 is located upstream of the film removal station, such as stripping station 313. The pulling station may include a nip puller 312a. The pulling station may be used to control a predetermined distance traveled by the overall system comprising of substrate, substrate coated with resin, composite laminate, bottom film and top film as part of the semi-continuous operation of the process.

Wet-Out Stations

In one embodiment, the system includes at least one wet-out station configured to promote integration of the resin 106 into the substrate in the resin-substrate combination. The system, such as system 300, optionally includes plural wet-out stations. In one embodiment of the present invention, at least one wet-out station includes a preheating station, which is configured to initiate polymer reaction and maintain an elevated temperature of the resin-substrate combination as it moves in a downstream direction of the system. Maintaining an elevated temperature of the resin-substrate combination may be achieved by means of ultraviolet light, heat lamps, or other heating methods as would be understood by persons skilled in the art. In yet another embodiment, at least one wet-out station is configured to apply a vacuum to remove any undesired trapped air, contaminants, and/or particulates.

Further, as see in FIG. 3A, a wet-out station, such as soaking station 1 (37) and soaking station 2 (38), may be located downstream of a resin dispenser, such as resin dispensing system 34. In one example, at least one wet-out station, such as soaking station 1 (37) and soaking station 2 (38), is located upstream of the press 39. In one embodiment, the wet-out station may include an edge sealer configured to seal edges of the upper film to edges of the lower film, thereby reducing VOC emissions. The edge sealer may include one or more brushes (37a, 38a). The edge sealer will remove, or resist or prevent entry of, any undesired dust, impurities, foreign objects, and/or other contaminants or unwanted materials from the resin-substrate combination 16 that might cause unacceptable defects in the final product 314.

Index Station

In yet another embodiment, as seen in FIGS. 3A-3D, the system 300 includes a substrate indexing station, such as fabric index and cutting station 32, configured to index a position, such as a position 320, of the substrate relative to a position of the lower film 316. In one example, the substrate indexing station 32 comprises a station wherein a plurality of substrates 31a is stacked, juxtaposed, fully overlapped, or partially overlapped in a predetermined pattern for resin application. In one embodiment, the substrate indexing station 32 includes an inspection station configured to detect deformities in one or more substrate 31a prior to resin application.

Referring now to FIGS. 3A-3D, the system further comprises a cutter, such as cutter 32b, configured to cut the substrate, such as substrate 31a. In one example, the cutter 32b includes a CNC cutter. In another example, the cutter is coupled with a vacuum suction capability to remove undesirable dust/debris.

Cooling Station

As illustrated in FIG. 3A, the system 300 further comprises a cooling station, such as cooling station 311, located upstream from the film removal station, such as stripping station 312. The cooling station 311 optionally includes an active cooling function (for example by air flow or cooling air or surfaces). Alternatively, it may provide a position for the material to rest and cool by passive heat transfer to room air.

Resin Dispenser With Pump

As seen in FIGS. 1A and 3A, the resin dispenser, such as resin dispensing system 34, includes a pumping system 34a having a pump configured to advance resin, such as resin 106, for application to the substrate, such as substrate 31a. The pump of system 34a can be a peristaltic pump, a metering pump, a gear pump, a diaphragm pump, or a Stokes pump, for example. Further, the pumping system 34a selected depends upon the resin 106 used and can be a single or multiple component system.

In one embodiment, as illustrated in FIGS. 1A, 9A-9D, the resin dispenser 91 is configured to apply resin, such as resin 106, by spraying, dripping, dipping, flowing, or bathing the resin 106 in or on the substrate, such as substrate 31a. In the illustrated embodiments, the resin dispenser 91 is configured to spray the resin 106 onto the substrate 31a. In such an embodiment, the resin dispenser 91 includes a nozzle, such as spray head 921, configured to apply resin 106 in a pattern such as a flat pattern (93, 94).

As generally described above and illustrated in the figures, the panel production system makes it possible to use a carrier film (316, 317) of plastic underneath a cut fabric or substrate 31a, with the film (316, 317) extending at least partially or all the way to the other end of the production line from the upstream end portion 102 to the downstream end portion 104. Nip pullers, such as nip pullers 312a, at the downstream end of the line pull the carrier film (316, 317) and the fabric or substrate 31a above it.

Resin

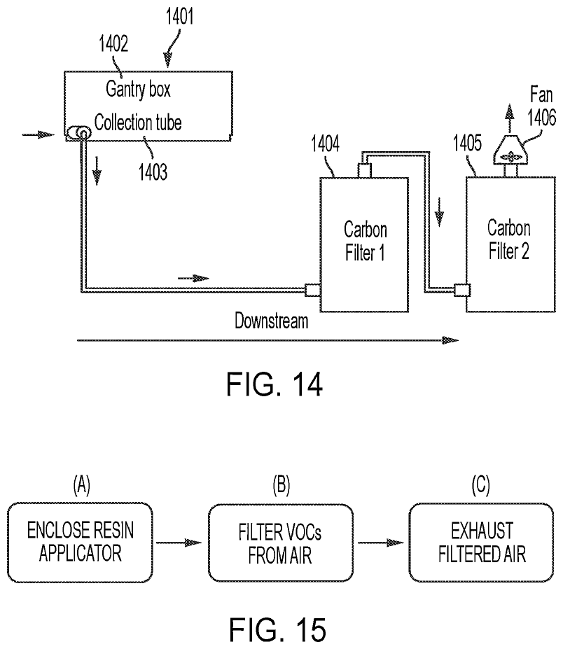

In exemplary embodiments, a substrate in the form of a dry fabric, such as substrate 31a, is pulled into an enclosure, such as gantry box 321, where a resin, such as resin 106, includes premixed MMA/PMMA formulation, along with ingredients such as reaction initiator (peroxide), reaction inhibitor, color package, filler (such as fine clay), surfactant (to reduce surface tension), impact modifier, and additional optional additives, is sprayed onto the fabric or substrate 31a. Referring to FIG. 14A, the enclosure 321 ensures that all or substantially all VOCs are contained, and an exhaust such as a fan 1406 continuously blows or otherwise draws the undesired air into one or more containers, such as drums 41a, with filter material such as activated carbon inside drums 41a to capture the VOCs.

The low viscosity of the resin mix 106 (<500 cps, or more preferably up to 250 cps, or most preferably about 100 cps or less, for example) results in rapid impregnation of the fabric or substrate material 31a as it driven by forces of capillarity. Although viscous forces can be used, the lower viscosity resin 106 makes it possible to decrease the soak time required for good wetting of the fabric or substrate 31a.

The substrate-resin combination 16 is pulled out of the enclosure, such as gantry box 321, by the nip pullers 312a. As it is being pulled, another layer of plastic film 317 is added above the wet fabric or substrate 16. This film 317, much like the bottom film 316 described above, is pulled with the same nip pullers 312a.

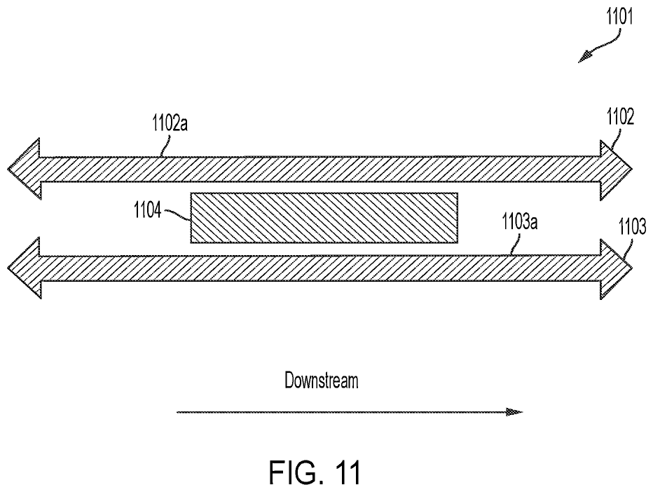

The top film layer 317, wet fabric/substrate 316, and bottom film layer 316 form a closed system limiting or eliminating escape of VOCs. Accordingly, the top and bottom films (317, 316) form a die, such as die 1101 of FIG. 11A. The combination of materials and components forming the die 1101 (top film layer, wet fabric/substrate, and bottom film layer) is pulled into a pre-heated and pre-programmed press, such as press 39. Under optimized conditions of temperature, pressure and time, the reaction is initiated, and the resin is cured. After the press cycle, the film/laminate/film combination 1101 is pulled through the nip-rolls and the panel, such as laminate 1005, is removed. The top and bottom film layers (1003, 1004) are wound into a roll (1002, 1004) for ease of handling and removal.

Tool-Less Die Assembly

Referring now to FIGS. 1A, 3A, 10A, and 11A, a die 1101 is provided for use with a press 39 for forming composite products, such as laminate 1005, including a substrate 31a and a resin, such as resin 106, integrated with the substrate 31a. The die 1101 includes a lower film, such as film 1103, configured for movement relative to the press 39 in a downstream direction extending from an upstream end of the press 39 toward a downstream end of the press 39. The lower film 1103 has an upper surface, such as surface 1103a, positioned to support a combination of the substrate and the resin, such as combination 1104. The lower film 1103 also has a continuous length selected to extend beyond the upstream end of the press 39 in an upstream direction and beyond the downstream end of the press 39 in the downstream direction.

The die 1101 also includes an upper film 1102 configured for movement relative to the press 39 in the downstream direction extending from the upstream end of the press 39 toward the downstream end of the press 39. The upper film 1102 has a lower surface, such as 1102a, positioned and configured to contact the combination 1104 of the substrate and the resin. Like the lower film 1103, the upper film 1102 also has a continuous length selected to extend beyond the upstream end of the press 39 in the upstream direction and beyond the downstream end of the press 39 in the downstream direction.

In the die 1101, a seal is formed by contact between the upper surface 1103a of the lower film 1103 and the lower surface 1102a of the upper film 1102. The thus-formed seal is positioned to at least partially surround the substrate. The seal extends along portions of the continuous lengths of the lower film 1103 and the upper film 1102. The seal also extends lateral to the continuous lengths of the lower film 1103 and the upper film 1102. The lower film 1103, the upper film 1102, and the seal together define a die interior configured to enclose the combination 1104 of the substrate and the resin 106.

In one embodiment, the seal forms a perimeter to at least partially surround the substrate 31a. The perimeter has a shape generally corresponding to a shape of the substrate 31a, thereby reducing the amount of resin 106 squeezed out of the substrate 31a upon application of pressure.

The lower film can include polyethylene terephthalate or polycarbonate, such as lower PET unwind 33. In one embodiment, the lower film can include polyethylene or polyetherimide or other suitable polymeric materials. In one example, the lower film 1103 is 0.01 inch or less in thickness. In another example, the lower film 1103 has a 0.075 mm nominal thickness.

Similarly, the upper film optionally includes polyethylene terephthalate or polycarbonate, such as upper PET unwind 35. In one embodiment, the upper film 1102 is 0.01 inch or less in thickness. Additionally, the upper film 1102 may have a nominal thickness. The upper film 1102 and the lower film 1103 may be the same in terms of at least one of dimensions, composition, and source.

The film substrate (1102, 1103) according to one example is formed from polyethylene terephthalate, being 60 to 63 inches in width, and a thickness of 0.075 mm. The thickness may be up to 0.254 mm thick (0.01 in) or thicker. The width of the film (1102, 1103) is dictated by process size and could be up to 5 meters in width dependent on the substrate, such as substrate 31a, and finished product size, such as laminate 1005.

Although it is contemplated to use the same films for top and bottom films (1102, 1103), different materials can be used for the top and bottom films (1102, 1103). Also, other film materials can be used dependent on the polymers and resin types to be used for a particular product and the release properties for a selected resin matrix. Other films and or release films may also be needed for thermoset resin systems.

As described above, systems according to aspects and embodiments of this invention make it possible to make a closed “mold,” such as die 1101, without the need for a mold into which resin, such as resin 106, is injected or otherwise introduced. In other words, the top and bottom films (1102, 1103) become the mold, and seals between the top and bottom films formed by the press 39 (to prevent out-flow of the liquid resin under pressure) become part of that mold.

Panel Production Process

Referring now to FIGS. 1A, 2A, 3A-3D and 12A, an embodiment of a process for producing composite products including a substrate 31a and a resin, such as resin 106, integrated with the substrate or fabric 31a includes supplying a lower film 316 to introduce the lower film 316 in a downstream direction.

In step (A), lower film 316 is supplied to introduce the lower film 316 in a downstream direction.

In step (B), a substrate 31a is supplied to introduce the substrate 31a in the downstream direction and onto the lower film 316.

In step (C), a resin 106 is dispensed to apply the resin 106 to the substrate 31a to form a resin-substrate combination 16.

In step (D), an upper film 317 is supplied to introduce an upper film 317 onto the resin-substrate combination 16.

In step (E), pressure is applied to the resin-substrate combination 16 through the upper film 317 and the lower film 316.

Finally, in step (F), the lower film 316 and the upper film 317 are removed from the resin-substrate combination 16.

Referring now to FIGS. 1A, 3A-3D and 12B, a process for producing composite products in accordance with an embodiment of the present invention is disclosed.

In step (A), a lower film supply, such as lower film supply 33, is configured to introduce a lower film, such as lower film 33b, for introduction into the system in a downstream direction towards the press 39.

In step (B), an upper film supply, such as upper film supply 35, is configured to introduce an upper film, such as upper film 35b, for introduction into the resin dispenser, such as resin dispensing system 34, in a downstream direction towards the resin dispenser 34.

In step (C), a substrate, such as substrate or fabric 31a, is supplied to introduce the substrate 31a in the downstream direction.

In step (D), resin, such as resin 106, is prepared for application onto the substrate 31a.

In step (E), the substrate 31a is cut from a larger substrate.

In step (F), a substrate supply, such as station 31, supplies substrate 31a onto lower film 33b and in the downstream direction toward a resin dispenser 34.

In step (G), resin dispenser 34 dispenses resin 106 to apply resin 106 onto the substrate 31a to form a resin-substrate combination, such as combination 16.

In step (H), an upper film, such as upper film 35b, is applied onto the resin-substrate combination 16, the upper film 35b providing a barrier against the escape of VOCs from the resin-substrate combination as the resin-substrate combination 16 exits the resin dispenser 34 and moves in a downstream direction to a next station, such as soaking station 1 (37) and a soaking station 2 (38), each including an edge sealer including one or more brushes (37a, 38a) configured to seal edges of the upper film 35b to edges of the lower film 33b, thereby reducing VOC emissions. Additionally, resin temperature and viscosity control, including the control of temperature at one or more soaking or wet-out stations, can be performed for crosslinking control and to build up molecular weight.

In step (I), the resin substrate combination moves in a downstream direction toward a press, such as press 39.

In step (J), press 39 is configured to apply pressure to the resin-substrate combination 16 through the upper film 35b and the lower film 33b when the resin-substrate combination 16 is co-located with the press 39.

In step (K), when the press 39 opens and the resin-substrate combination 16 is pulled to a cooling station 311, which is located upstream from a film removal station 18, such as stripping station 313.

In step (L), a pulling station, such as station 312 having a nip puller 312a, configured to pull the lower film 33b and the upper film 35b, with the resin-substrate combination 16 between the lower film 33b and the upper film 35b, in a downstream direction. At a downstream end portion 104 of the system, reinforced composite product 314 is delivered.

In one example, reinforced composite product 314 comprises a substrate, such as substrate 31a, a resin 106 integrated with the substrate 31a, and has an exterior surface characterized by uniformity of at least one of color, weave pattern, and surface veil appearance. In another example, reinforced composite product 314 comprises a substrate, such as substrate 31a, a resin 106 integrated with the substrate 31a, and has an exterior surface characterized by uniformity of at least one of thickness, fiber content, thickness after secondary pressing, noise generation in ultrasonic C-scan, fiber content, and cross-section.

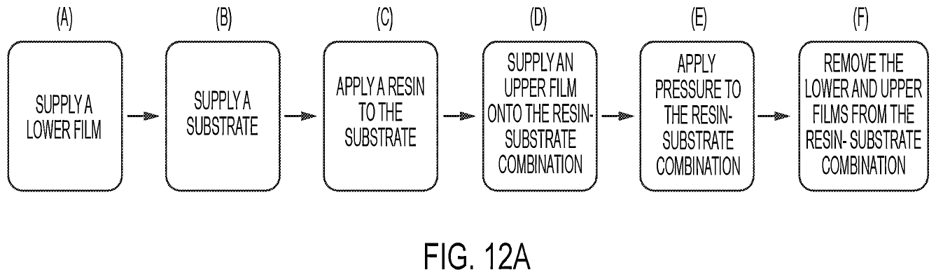

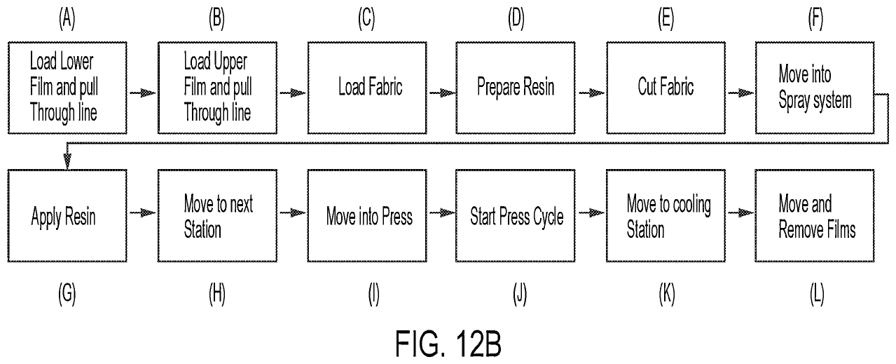

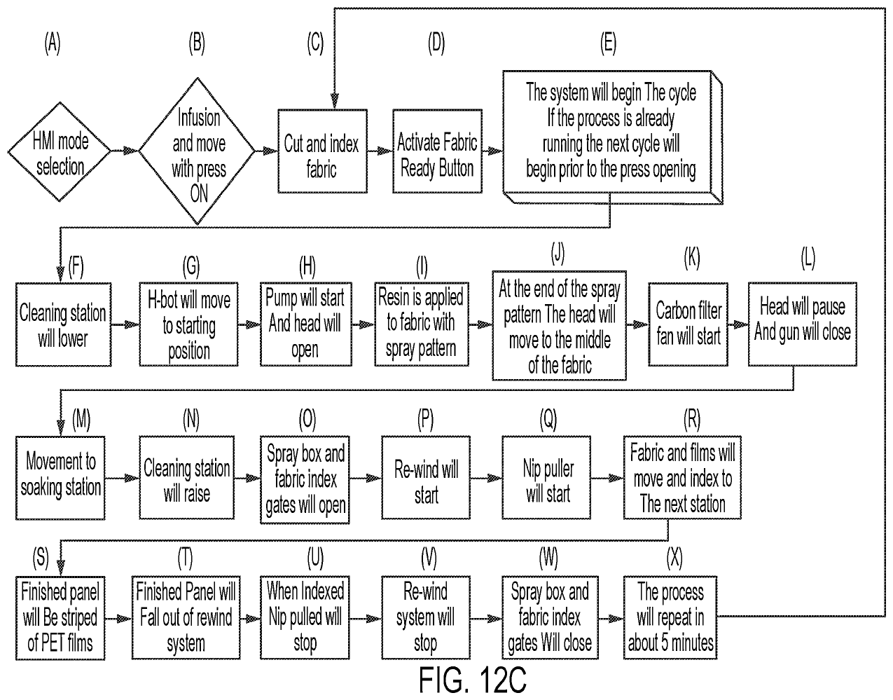

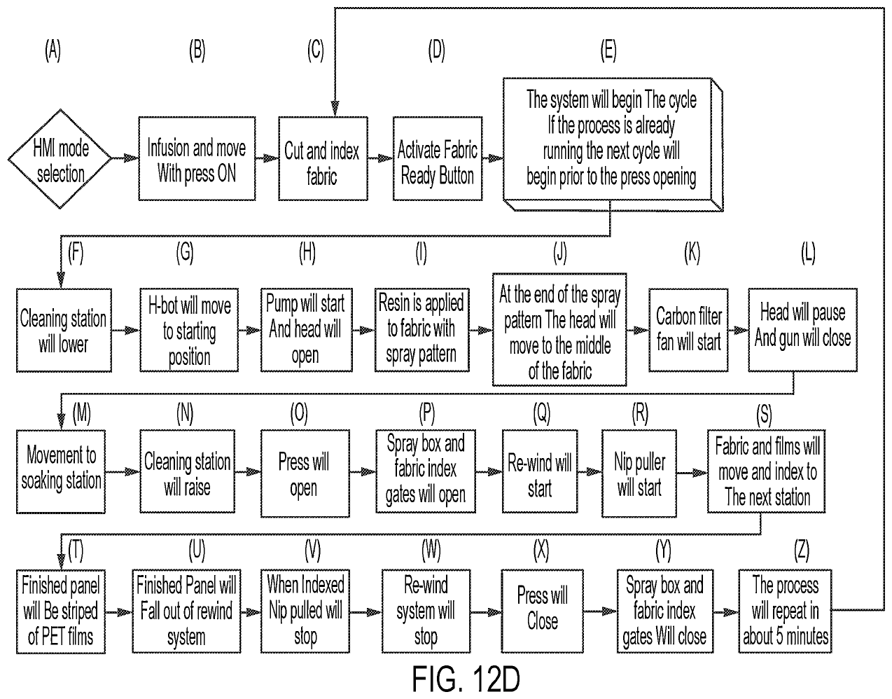

Referring now to FIG. 12C, a process for producing composite products in accordance with an embodiment of the present invention is disclosed, generally following the steps below:
Step (A): Mode selection
Step (B): Infusion and move with press ON
Step (C): Cut and index fabric
Step (D): Activate fabric ready button
Step (E): The system will begin the cycle. If the process is already running the next cycle will begin prior to the press opening.
Step (F): Cleaning station will lower.
Step (G): H-bot will move to starting position.
Step (H): Pump will start and head will open.
Step (I): Resin is applied to fabric with spray pattern.
Step (J): At the end of the spray pattern the head will move to the middle of the fabric.
Step (K): Carbon filter fan will start.
Step (L): Head will pause and gun will close.
Step (M): Movement to soaking station.
Step (N): Cleaning station will raise. The polymer spray tip is expected to have some residual polymer on it after the prior spray action is complete. For reactive polymer systems or polymer systems that may harden over a period of time, it may be important to ensure that the spray tip is maintained in a workable state and ready for the next spray cycle. The cleaning station in Step (N) is designed to hold a suitable solvent that can dissolve the polymer being used. At the end of every spray cycle, the spray tip is optionally returned to a pre-programmed “home” position. Following this, the cleaning station, with the solvent in it, raises to immerse the spray tip in the solvent. Alternatively, the spray tip can be lowered into the solvent. This allows the solvent to dissolve and remove the polymer from the spray tip or, in the least, keep the polymer soft enough to enable process continuity and keep the resin spray tip ready for the next round of coating the substrate with the polymer formulation.
Step (O): Spray box and fabric index gates will open.
Step (P): Re-wind will start.
Step (Q): Nip puller will start.
Step (R): Fabric and films will move and index to the next station.
Step (S): Finished panel will be stripped of PET films.
Step (T): Finished panel will fall out of rewind system.
Step (U): When indexed, nip puller will stop.
Step (V): Re-wind system will stop.
Step (W): Spray box and fabric index gates will close.
Step (X): The process will repeat in about 5 minutes (back to Step (C)).

Referring now to FIG. 12D, a process for producing composite products in accordance with another embodiment of the present invention is disclosed, generally following the steps below:
Step (A): Mode selection
Step (B): Infusion and move with press ON
Step (C): Cut and index fabric
Step (D): Activate fabric ready button
Step (E): The system will begin the cycle. If the process is already running the next cycle will begin prior to the press opening.
Step (F): Cleaning station will lower.
Step (G): H-bot will move to starting position.
Step (H): Pump will start and head will open.
Step (I): Resin is applied to fabric with spray pattern.
Step (J): At the end of the spray pattern the head will move to the middle of the fabric.
Step (K): Carbon filter fan will start.
Step (L): Head will pause and gun will close.
Step (M): Movement to soaking station.
Step (N): Cleaning station will raise. As noted above, the cleaning station containing solvent will raise to submerge the spray nozzle and to dissolve or soften any residual resin from the prior spray operation.
Step (O): Press will open.
Step (P): Spray box and fabric index gates will open.
Step (Q): Re-wind will start.
Step (R): Nip puller will start.
Step (S): Fabric and films will move and index to the next station.
Step (T): Finished panel will be stripped of PET films.
Step (U): Finished panel will fall out of rewind system.
Step (V): When indexed, nip puller will stop.
Step (W): Re-wind system will stop.
Step (X): Press will close.
Step (Y): Spray box and fabric index gates will close.
Step (Z): The process will repeat in about 5 minutes (back to Step (C)).

In one embodiment, the process pathways of any one of 12A-12D includes heating the resin-substrate combination 16 to an elevated temperature above an ambient temperature. The elevated temperature is selected to accelerate curing or polymerization of the resin of the resin-substrate combination.

In yet another embodiment, the process pathways of any one of 12A-12D further comprises sealing a perimeter of the lower film 316 and the upper film 317 to at least partially surround the substrate 31a. The perimeter can have a shape generally corresponding to a shape of the substrate 31a, thereby reducing the amount of resin squeezed out of the substrate upon application of pressure.

In one example, the process pathways of any one of 12A-12D includes applying pressure to the resin-substrate combination 16 for a predetermined period of time. The process may include varying the amount of pressure applied to the resin-substrate combination 16 as a function of time during the predetermined period of time.

### VOC Capture System

Process improvements are beneficial and needed because the release of Volatile Organic Compounds (VOCs) is regulated by different national and local governments, resulting in the quantity of methyl methacrylate (MMA) that can used during manufacturing being restricted. In order to reduce the quantity of VOCs released, the processes and systems described herein are designed to reduce emissions and maximize possible manufacturing output.

In order to capture VOCs, composite products in the form of panels are cured in between two pieces of film (316, 317), such as a polyester release liner. A substrate such as fabric 31a is carried on the film 316 as it is moved from a resin application zone such as a spray-box 321 to a heat-press 39 and out from the heat-press 39. To monitor VOC emissions, fabric and release liner weights are recorded throughout the process so that they can be subtracted from the weights of the cured panels, such as laminate 1005, at the end of the process line. Final resin weight can be calculated by this method. Initial weights of carbon-filter drums, such as containers 41a, can also be recorded, and initial weights can be subtracted from final weights to obtain the net weight of VOCs captured.

Compared to other manufacturing methods such as the first process described herein, methods according to aspects of this invention surprisingly provide an improvement of more than 50% in terms of the reduction of VOC emissions, more preferably more than 60%, and even more preferably more than 70%. This improvement over other manufacturing processes makes the improved process an important step in the direction to reduce VOCs and at the same time increase manufacturing capacity.

With the release of Volatile Organic Compounds (VOCs) monitored closely and regulatory restrictions on the quantity of material such as methyl methacrylate (MMA) that can be used, the process improvements have been made to mitigate release of VOCs during manufacturing. The reduction of VOCs released will consequently allow an increase in the amount of MMA that can be used for processing.

Processes described herein utilize a resin infusion method for creating thermoplastic composite panels. These processes have been designed to run as a substantially or completely closed system, allowing the full polymerization of MMA and the capture of any VOCs that may otherwise escape during processing.

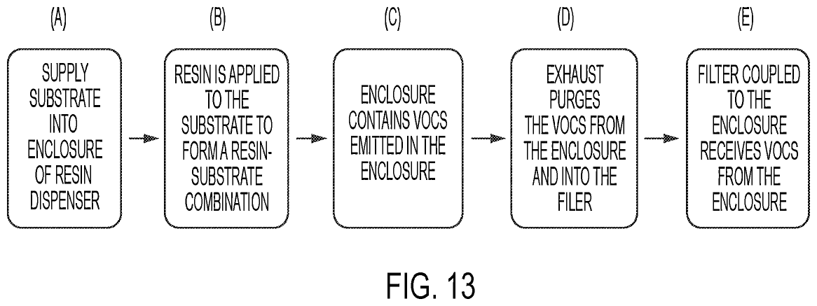

According to one embodiment, as illustrated by FIG. 13A, a process for capturing VOCs during the production of composite products including a substrate and a resin integrated with the substrate is disclosed.

In step (A), a substrate, such as substrate 31a, is introduced into an enclosure, such as gantry box 321, of a resin dispenser, such as resin dispensing system 34.

In step (B), resin, such as resin 106, is applied onto the substrate 31a to form a resin-substrate combination, such as combination 16.

In step (C), the gantry box 321 is configured to contain VOCs emitted in the gantry box 321 when the gantry box 321 is closed.

In step (D), an exhaust, such as fan 1406 is configured to reduce pressure within the gantry box 321, as well as purge the VOCs from the gantry box 321 and into the filter, such as carbon filters 1404, 1405.

In step (E), one or more filters, such as carbon filters 1404 and 1405, is/are configured to receive VOCs from the gantry box 321.

As explained generally above, VOC capture is accomplished using one or more activated carbon drum filters, such as filters 1404 and 1405. In one embodiment, as seen in FIG. 14A, two activated carbon drum filters are used. A scale is used to weigh the captured VOCs. The precision of the scale can be selected to achieve the accuracy desired for measuring capture percentages. For example, accuracy can be improved by using a more precise scale and/or smaller filter canisters. It is preferred, however, to use larger drums in production for cost efficiency.

Gross losses from a substantially closed system may in some cases be greater than one percent. Such losses may result from one or more of three sources, or a combination of any. One source is overspray of resins. Another source is leaks of VOCs during processing. Yet another source is less than full polymerization of the resin formulation caused by either the formulation and/or heating duration. Accordingly, any losses of VOC capture can be controlled by reducing or eliminating overspray of resins, reducing or eliminating leaks of VOCs during processing, and/or promoting increased or full polymerization of the resin formulation. As illustrated in FIG. 4B, process control stations, such as control systems 42, are configured to control various process parameters, including activation of a fan (on/off) of the VOC capture system. The parameters may be programmed to run in automatic or manual mode.

Using VOC detection systems, such as the RAE System's MiniRAE 300 PGM7320 VOC meter, VOCs escaping from the processing system can be detected at various locations in the system. For example, monitoring for VOC escape can be made at the exit gate, such as exit gate 318 of FIG. 3D, when the gate is in the closed position, during the resin dispensing process; at the edges of the polymer release liner in the wet-out station, such as soaking station 1 (37) and soaking station 2 (38) of FIG. 3A, where the resin-impregnated fabric 16 sits while it is waiting to be moved into the heat press; and after the panel is cured and the polymer release film is removed as it moved out of and away from the heat press toward a downstream end portion of the system. VOC escape at these locations can be reduced or eliminated by providing seals on the gates, by keeping the release liner closed at its edges while it moves from a gantry 321 (or other form of enclosure in which resin is applied, such as resin dispenser 91) to the press 31, and/or by sealing the press 39 to retain heat and resin inside the press 39 and deliver a more fully polymerized product, such as laminate 1005.

VOC Capture Assembly (Equipment Assembly and Subassemblies)

According to one embodiment of the present invention, as illustrated in FIG. 14A, a system for capturing VOCs during the production of composite products including a substrate and a resin integrated with the substrate is provided. The system includes a resin dispenser 1401 positioned to apply the resin, such as resin 106, to the substrate 31a to form a resin-substrate combination 314. The resin dispenser 34 includes an enclosure, such as gantry box 1402, into which the substrate 31a can be introduced when the enclosure 1402 is open, the enclosure 1402 being configured to contain VOCs emitted in the enclosure 1402 when the enclosure 1402 is closed. The system also includes a filter, such as carbon filters 1404 and 1405, coupled to receive VOCs from the enclosure 1402 of the resin dispenser 1401. The system also includes an exhaust, such as fan 1406, configured to reduce pressure within the enclosure 1402 and positioned to purge the VOCs from the enclosure 1402 and into the filter (1404, 1405). The exhaust 1406 is operable when a gate or entrance or exit of the enclosure 1402 is open to allow the substrate 31a to enter the enclosure 1402 and to allow the resin-substrate combination 314 to exit the enclosure 1402.

As illustrated in FIGS. 3A-3D and 9A, the resin dispenser 91 includes a spray nozzle, such as spray head 921, and the enclosure 34 includes a spray box 321 having an upstream gate, such as entry gate 319, that opens to allow the substrate 31a to enter the enclosure 34, and a downstream gate, such as exit gate 318, that opens to allow the resin-substrate combination 314 to exit the enclosure 34.

In one embodiment, the system includes an upper film supply 17 located upstream of the downstream gate, such as exit gate 318, of the enclosure 34 and configured to introduce an upper film 317 into the system, in a downstream direction toward the downstream gate 318 of the enclosure 34, and onto the resin-substrate combination 314. The upper film 317 provides a barrier against the escape of VOCs from the resin-substrate combination 314 as the resin-substrate combination 314 exits the downstream gate 318 of the enclosure 34. The enclosure 34 of the resin dispenser 91 may also include an upper film gate, such as gate 916, positioned to allow entry of the upper film 317 into the enclosure 34. In one example, the upper film gate 916 is positioned in a top portion of the enclosure 34 to allow passage of the upper film 317 toward an upper surface of the substrate 31a.

As shown in FIG. 14A, the filter includes a canister (1404, 1405) containing a filter substrate. The filter may include plural canisters (1404, 1405) connected in parallel or in series. In one example, the filter includes a source of UV radiation. In another example, the filter includes a vapor condenser configured to capture VOCs. Alternatively, or additionally, the filter substrate includes activated carbon.

### VOC Capture Process

Referring to FIGS. 3A-3D, 14A, and 15A, a process is provided for capturing VOCs while producing composite products including a substrate 31a and a resin, such as resin 106, integrated with the substrate 31a to form a resin-substrate combination 314.

In step (A), the process includes opening an upstream gate, such as entry gate 319, of an enclosure 34, and actuating an exhaust, such as fan 1406, to reduce pressure within the enclosure 34 when the upstream gate 319 of the enclosure 34 is opened to receive substrate 31a in the enclosure 34 and when the upstream gate 319 of the enclosure 34 is closed upon entry of the substrate 31a.

In step (B), resin is applied to the substrate 31a to form the resin-substrate combination 314 in the enclosure 34, and VOCs are exhausted from the enclosure 34 and into a filter (1404, 1405).

In step (C), the process includes actuating the exhaust 1406 to reduce pressure within the enclosure 34, opening a downstream gate, such as exit gate 318, of the enclosure 34, and delivering the resin-substrate combination 314 from the enclosure 34 through the downstream gate 318 of the enclosure 34.

In one embodiment, the process can also include introducing an upper film 317 in a downstream direction toward the downstream gate 318 of the enclosure 34 and onto the resin-substrate combination 314, the upper film 317 providing a barrier against the escape of VOCs from the resin-substrate combination 314 as the resin-substrate combination 314 exits the downstream gate 318 of the enclosure 34.

In yet another embodiment, the process can also include sealing the downstream gate 318 of the enclosure 34 against the upper film 317. Such sealing can be provided in various ways such as by using a sealing surface. Such a sealing surface can, for example, include a gasket or a contact blade or other structure capable of reducing or preventing the passage of gases from within the enclosure.

Also, the process may include actuating the exhaust 1406 when the upstream gate 319 of the enclosure and the downstream gate 318 of the enclosure 34 are closed. The resin can be applied while the exhaust 1406 is actuated and while the upstream gate 319 of the enclosure 34 and the downstream gate 318 of the enclosure 34 are closed. At least one of the upstream gate 319 of the enclosure 34 and the downstream gate 318 of the enclosure 34 can be opened while the exhaust 1406 is actuated, and the resin-substrate combination 314 can be delivered from the enclosure 34 through the downstream gate 318 of the enclosure while the exhaust 1406 is actuated. The exhaust can be de-actuated when the upstream gate 319 of the enclosure 34 and the downstream gate 318 of the enclosure 34 are both closed.

### Reinforced Composite Panels

In addition to the improvements noted above, the system and processes according to embodiments of this invention produce reinforced composite panels with improved properties. Among other improvements, the reinforced composite panels have improved surface properties and reduced variation of properties across the panel.

According to an embodiment of the present invention, a reinforced composite product 1501 includes a substrate 31 and a resin integrated with the substrate 31a. The reinforced composite product 1501 has an exterior surface 1502 characterized by uniformity of at least one of color, weave pattern, and surface veil appearance.

The substrate, such as substrate 31a, may include fibrous material, non-fibrous material, or a combination thereof. In one example, the substrate includes metallic material, non-metallic material, or a combination thereof. In another example, the substrate includes one or more of glass, carbon, ceramic, basalt, steel, and cellulosic fiber materials. In yet another embodiment, the substrate includes one or more of continuous, discontinuous, woven, non-woven, crimped, uncrimped, uni-directional, multi-directional, porous, and non-porous materials and hybrids or combinations thereof.

The substrate 31a may be substantially planar and having an outer periphery. In one example, the outer periphery of the substrate 31a is a geometric shape, a predetermined shape, or an arbitrary shape. For example, the geometric shape can be rectangular or square.

In one embodiment, the substrate 31a is cut from a larger substrate. The substrate 31a may be cut using a CNC or nesting operation. It can be provided with any regular or irregular shape by programming the CNC to cut the substrate 31a. The substrate 31a may be cut or otherwise formed into a desired shape in line with the composite production line, such that the process can be continuous or semi-continuous. Alternatively, the substrate 31a can be pre-cut or pre-formed for subsequent processing in the composite production line.

In one example, the substrate 31a has a thickness (T) not exceeding about 5 mm. However, the substrate 31a may be thicker or thinner than 5 mm depending on the final product to be produced.

The resin, such as resin 106, can include a thermoplastic polymer or a thermoset polymer having a viscosity up to 5000 cps. In another example, the resin 106 includes a thermoplastic polymer or a thermoset polymer having a viscosity up to 500 cps, or more preferably up to 250 cps, or most preferably about 100 cps or less.

In addition, the resin 106 may include a polymer, monomer, or combination thereof that can be cross-linked for polymerization. Further, the resin 106 can include one or more of a color package, a reaction initiator, a reaction inhibitor, an impact modifier, a flame retardant, a lubricant, a light stabilizer, an electrical or thermal conductor additive, and an anti-oxidant, or combinations thereof.

Further, the resin 106 may include a thermoplastic polymer that is dissolvable into solvent to reduce viscosity. In one example, the resin 106 includes polycarbonate dissolved in dichloromethane (DCM). Finally, the resin 106 can be configured to be applied by spraying as noted above.

According to another aspect of the invention, a panel 314 produced according to the processes described herein can have a narrower distribution of properties in terms of at least one of color, mechanical properties, thickness, and c-scan. Also, the properties can have a narrower distribution on a bell curve and the position of that narrower distribution can be increased (moved to the right on the bell curve) or decreased (moved to the left on the bell curve) as compared to prior processes.

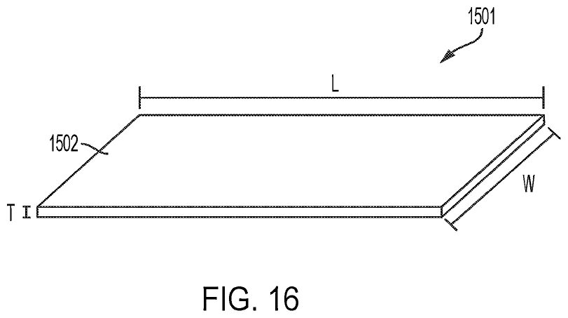

Referring now to FIG. 16A, a reinforced composite product 1501 includes a substrate 31a and a resin, such as resin 106, integrated with the substrate 31a, and the reinforced composite product 1501 is characterized by uniformity of at least one of thickness, fiber content, thickness after secondary pressing, noise generation in ultrasonic C-scan, resin content, and cross-section.

### EXAMPLES

### VOC Capture System

A mass-balance experiment was performed in triplicate to determine the VOC emissions from the composite panel production system. The mass-balance experiment was done in triplicate over three days at ambient conditions. Intermediates of a resin included monomer (MMA) and initiator (BP-75). The weight of the resin that was added into a reservoir tank was recorded as the initial weight.

Panels were cured in between two pieces of polyester release liner that the fabric rode on as it was moved from a spray-box to a heat-press and out. Fabric and release liner weights were recorded throughout the process so that they could be subtracted from the weights of the cured panels at the end of the process line. Final resin weight was calculated by this method.

Initial weights of the carbon-filter drums were recorded before each of three trials. Initial weights were subtracted from final weights at the end of each trial to obtain the net weight of volatiles captured.

Compared to the first process described herein, the composite panel production system and improved process provided an improvement of 70.6% in terms of the reduction of VOCs. The improvement over the first process makes the composite panel production system an important step in the direction to reduce VOCs and increase manufacturing capacity.

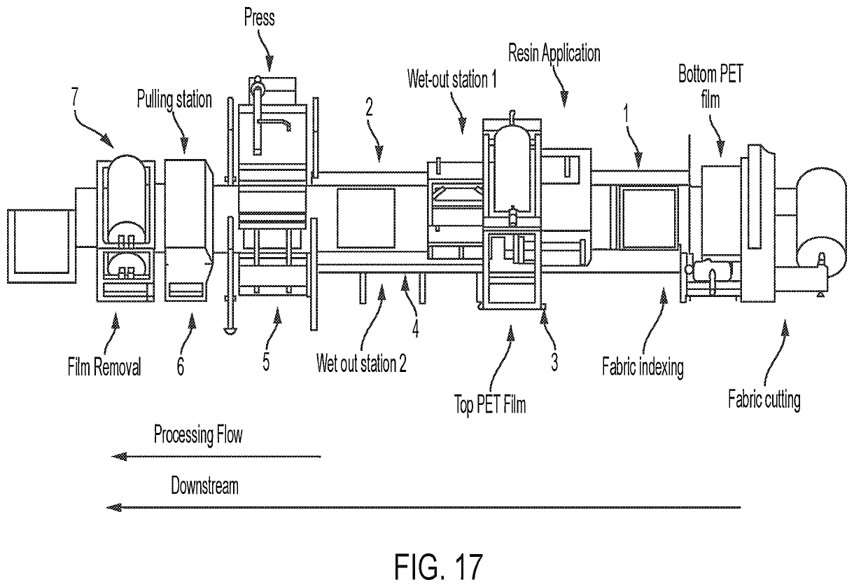

In each trial, resin was weighed and added to the composite panel production machine and run through the system. Losses were accounted for by subtracting the output quantity of resin from the input quantity. Activated carbon filters were used in series with an exhaust fan to pull fumes out of a closed dispensing gantry box of the improved process at all times the system was open, whether during normal operation or troubleshooting. The emissions generated from the composite panel production system and improved process are assumed here to be the gross (not accounting for carbon filter collection) and net losses (accounting for carbon filter collection) associated with the difference from resin-in to resin-out. The following equipment was used in the trials:
Fairbanks Scales 250 lb capacity drum scale
UWE APM-150, 300 lb capacity scale
Intelligent 3200 g capacity scale
Intelligent Intill-Lab Balance PC-6001, 6000 g capacity scale
Amprobe temperature and relative humidity logger
RAE Systems MiniRAE 300 PGM7320 VOC meter
H-Bot Resin Infusion Spray System
   Liquiflo® Gear Pump
   Moog Animatics SmartMotor™ (×3)
   MVP Spray Gun
Dah Tyan Hydraulic Machine (single-opening heat press)
   Model: DTEA—150
      The following materials were used in the trials:
MMA (Methyl Methacrylate monomer), such as those commercially available as provided by Arkema or Roehm.
Dibenzyl Peroxide 75% initiator (Arkema—A75; Akzo Nobel—Perkadox L-W75)
BW-1000
   2×2 12 k carbon and glass fiber fabric
   0.055″ nominal thickness
   1035±25 g/m2 areal weight
Polyester release film (Melinex 516 or PCI D2-2; 0.075 mm nominal thickness)
   The following testing conditions were used in the trials:
Room temperature was variable as ambient conditions dictated. Temperature ranged from 40° F. to 60° F. throughout the day.
Room relative humidity stayed somewhat consistent at 40±5%
   The following experimental process, as illustrated by FIG. 17, was used in the trials:
The activated carbon filter canisters were weighed and recorded prior to running the composite panel production system using the Fairbanks Scales drum scale. Exhaust was routed through these filter canisters to help capture VOCs that are present inside the spray gantry box during resin dispensing onto fabric.
Operators weighed and mixed the resin formulation (monomer and initiator) using the UWE and Intelligent digital scales. Resin was poured into the resin reservoir located near the resin application set-up 3. The resin pails were weighed using the gross-tare-net method to precisely measure and record the amount of resin that was put into the composite panel production system.
Every time before running the fabric through the composite panel production machine, each piece of fabric that was cut to size was weighed on the Intell-Lab Balance and recorded.
Fabric was then pulled into wet-out station 1. Resin was dispensed onto the fabric using a programed H-bot spray system. The resin-impregnated fabric was then moved down the line to the press where it was cured.
Heat press, had specified time, pressure and heat parameters based on the recipe cycle selected. This experiment was run using press cycle 9 running at 235° F., see Table 1 below.
After leaving the press, the cured panel was pushed out at the film removal station 7 at the end of the composite panel production system line. However, the polyester release film was left on, encasing the cured panel and all the flash.
The polyester film encasing the panel, with the cured panel inside, was cut to a predetermined size and the Intell-Lab Balance was used to weigh the panel with liner.
Throughout the process, polyester film pieces were cut and weighed to the same predetermined size as the cured panel with polymer film encasing. This was repeated 5 times, intermittently throughout the process to obtain a mean value for the predetermined-sized cut poly film. This mean value was used in conjunction with the individual fabric weights to determine cured resin content per panel.
The mean value of the polymer film and the weight of the dry fabric was subtracted from the total weight of the cured panel encased in the poly film to obtain the weight of the resin associated with each individual panel.
After running the system until the resin had been consumed, total panel count was recorded. The individual panel values for resin content on the cured panel were summed to give a total resin output value.
Activated carbon filter canisters were weighed at the end of the run/day. The weights were recorded. The difference between the ending weight and the starting weight was documented as the total amount of VOCs captured by the filter canisters.
The total resin weighed from the output was subtracted from the total resin put into the system. The difference was documented as gross loss.
The weight of VOCs captured in the filter canisters was subtracted from the gross loss weight value to give net loss. This value was recorded.

TABLE 1
Press Cycle 9

| Step_1 | Step_2 | Step_3 | Step_4 |
|---|---|---|---|
| +55.00 PSI | +60.00 PSI | +70.00 PSI | +75.00 PSI |
| 30 SEC | 30 SEC | 30 SEC | 180 SEC |

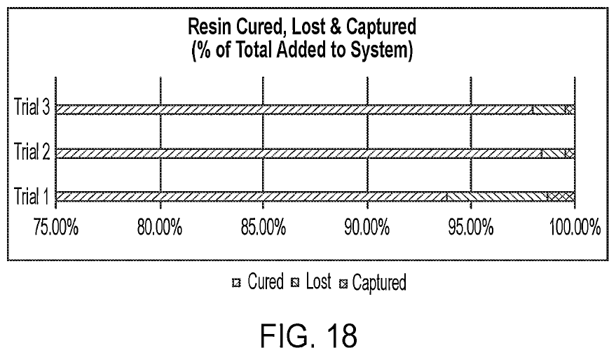

Three trials were performed. Trial 1 yielded the highest ‘resin lost’ and ‘collected in filter drum’ quantities, as seen in Table 2 and graphically depicted in FIG. 18.

TABLE 2
Resin Used, Cured, and VOCs Collected

| | | | | Collected in |
|---|---|---|---|---|
| | Resin Input | Resin Output | Resin Lost | C-Filter |
| Trial No. | (g) | (g) | (g) | Drum (g) |
| 1 | 26,160 | 24,895 | 1,264 | 362 |
| 2 | 30,256 | 29,921 | 335 | 136 |
| 3 | 27,821 | 27,368 | 452 | 124 |

Trial 1 also yielded the highest gross and net loss percentages as seen in Table 3 below. Gross loss was calculated to indicate loss of VOCs before any collection process was used. This result represents what is lost during processing due to process and equipment limitations. The resin used is cured to levels in accordance with the resin's product data sheet. Net loss values are representative of the process and equipment loss after utilizing the carbon-filter collection drums.

TABLE 3
Resin Loss & Capture Percentages and Projected Emissions

| | | | C-Filter | | VOCs |
|---|---|---|---|---|---|
| | Total | | Collection | | Lost & Not |
| Trial | Resin | Gross | (% of gross loss | | Captured |
| No. | (kg) | Loss | collected) | Net Loss | (kg) |
| 1 | 26.160 | 4.83% | 28.70% | 3.45% | 0.902 |
| 2 | 30.257 | 1.11% | 40.52% | 0.66% | 0.200 |
| 3 | 27.821 | 1.63% | 27.56% | 1.18% | 0.328 |

Referencing Tables 2 and 3, the carbon-filter collection drums on average collected 32% of the gross loss. Variation between trials can be attributed to resolution of the drum scale used to measure relatively small quantities. Measuring hundreds of grams in drums that weigh close to 100 kilograms with a precision limited to 45 grams lends itself to an inevitable error that equates to roughly +/−10% on the drum collection percentage. All trials were performed with as few adjustable variables as possible. The difference between Trial 1 from Trials 2 and 3 was the spray nozzle used in the resin dispensing system. Spray nozzle comparisons can be seen in FIG. 9B.

The spray nozzle used in Trial 1 caused overspray within the spray gantry box. The overspray stayed within the box throughout the processing of the panels. It is likely that the overspray that was left in the gantry box resulted in the higher than normal loss quantities as the resin did not make it onto the fabric and into the press for curing. For trials 2 and 3, a cleaner-applying spray nozzle was used.

The three trials that were conducted resulted in net loss of VOCs from our reduced emissions manufacturing process in the range of one to three percent, with the mean gross loss of resin being 2.52% by weight of the initial quantity added to the system. After accounting for the carbon collection, the final mean net loss of resin and/or volatiles to the environment was 1.76%. On average, the carbon filter system collected 32% of the lost resin/volatiles that made the difference between initial and final weights of the resin that was put into the system. Compared to the first process that allows for a loss of 6% to the environment, the composite panel production system and improved process is an improvement of 70.6%. This number is effectively higher if Trial 1 is omitted from the data. Trial 1 resulted in higher loss values because of the spray nozzle design as discussed above.

Embodiments of the systems and methods described herein provide a semi-continuous process to produce fabric reinforced panels where the resin is sprayed on the fabric using a programmable robotic head that travels over the fabric surface. The resin system primarily is Methyl Methacrylate (MMA)/Poly-Methyl Methacrylate (PMMA), which is a thermoplastic that can be considered to behave in some ways like a thermoset. The substrate can be in the form of woven fabric, non-woven/non-crimp fabric, different surface veils—all produced from various types of fibers or their combination.

Like thermoset resins, there is a chemical cross-linking reaction involved accompanied by an exotherm. However, according to embodiments of the resin system, post-curing the laminates can be thermoformed into a 3-D shape using heat and pressure.

According to exemplary embodiments of the disclosed process, benefits of the invention can include one or more of the following:
Reduced emission of Volatile Organic Compounds (VOCs) during processing of Methyl Methacrylate (MMA) and/or Poly-Methyl Methacrylate (PMMA) to produce fiber/fabric reinforced composite panels/laminates.
Reduced viscosity of processed resin from ˜20,000-30,000 centipoise (cps) to <500 cps with new processes.
Reduced amount of physical labor and manpower involved in production of the above-mentioned panels/laminates. This invention is also less labor intensive, requires reduced number of operators and is ergonomically preferred.
Reduced amount of wasted raw materials thus increasing the overall process yield.
Reduced number of process steps involved in production of the panels/laminates.
Elimination of resin injection die systems for composite production where such dies are made from metals (usually steel). In the present case the carrier films uniquely act as a closed die system and serve multiple roles including carrier films, enclosed system to limit release of VOCs, disposable tool and release paper for composite production, and a way to maintain process continuity.
Improved quality of panels/laminates making them more uniform in surface resin richness/quality and color as well as in uniformity of thickness and/or resin content.

### Thickness

An experiment was performed to compare the thickness of composite panels produced in accordance with the first process (FIG. 23) and with the improved process according to aspects of the present invention. The experiment was performed according to the following conditions.

Referring to FIG. 24, five samples, each having a length L of 10 inches and a width W of 10 inches, were obtained from different locations on a composite panel, having a length L of 50 inches and a width W of 38 inches, that was produced in accordance with the first process described above with reference to FIG. 23. Similarly, five samples, each having an L of 10 inches and a W of 10 inches, were obtained from different locations on a composite panel, having a length L of 50 inches and a width W of 38 inches, that was produced using the improved process in accordance with aspects of the present invention. As illustrated in FIG. 24, the samples 1, 2, 4, and 5 for each panel were obtained 6 inches away from the panel edges forming one of the four corners. Sample 3 was obtained from the approximate center of each panel.

To determine thickness measurements of each sample obtained from composite panels produced in accordance with the first process and the improved process according to aspects of the invention, five (5) samples, each 10″×10″ size, were cut from the large panel. Samples 1, 2, 4, and 5 (FIG. 24) were cut 6″ away from the panel's edges, and sample 3 was cut from middle of the panel. Twelve (12) thickness measurements were performed on each of the five (5) samples. The twelve (12) points of measurement were randomly selected. A Mitutoyo 0-1″ deep throat micrometer, with Ball/Ball tips at the top and bottom, was used for thickness measurements. More specifically, these listed steps were followed.
1. Each sample is positioned on a frame in alignment with reference index markings to ensure consistent placement of panels each time the thickness measurement is calculated.
2. Twelve (12) randomly selected points on each sample are measured simultaneously. There is a total of 24 thickness measurement probes, or 12 sets of corresponding pairs of probe tips. Each set of probe tips are so configured, such that when the measurement is initiated, the probe tips of each pair move toward each other until they come in physical contact with the panel.
3. Before the panel thicknesses are measured, the probes are actuated such that the probe tips of each pair contact each other and the reading is set to a “zero” position.
4. Once the “zero” position is set, the panel is placed in the frame and the probes are actuated again so they move toward each other and stop once contact is made with the panel surface. At this point the thickness of the panel is measured at all 12 points (simultaneously) and recorded.
5. The probe used for thickness measurement was a Mitutoyo Absolute 0-1″ deep throat micrometer with Ball/Ball tips at the top and bottom. The measurements were determined using MeasureLink Real Time software.

The mean thickness (measured in mm), standard deviation, and coefficient of variance of each sample was calculated. Compared to the first process, the improved process according to aspects of the invention provided an improvement in terms of the thickness of applied resin on the composite panels. For example, as seen in Tables 6 and 7 below, the present invention results in a smaller range of differences in resin thickness. In Table 8 below, the following properties are reported and are defined as follows:

“Average Thickness” is the average thickness of all thickness measurements; specifically, it is the average of Measurements 1-12 for Samples 1-5. In other words, it is the average thickness based on all 60 thickness measurements.

“Thickness Standard Deviation” is the standard deviation of all thickness measurements; specifically, it is the standard deviation of Measurements 1-12 for Samples 1-5. In other words, it is the standard deviation based on all 60 thickness measurements.

“Thickness Covariance” is the Thickness Standard Deviation (defined above) divided by the Average Thickness (defined above) times 100. By dividing the thickness standard deviation by the average thickness, the standard deviation value is normalized to account for various nominal thicknesses of panels being evaluated.

“Maximum Thickness” is the maximum thickness from Measurements 1-12 for Samples 1-5. In other words, it is the maximum thickness of all 60 measurements.

“Minimum Thickness” is the minimum thickness from Measurements 1-12 for Samples 1-5. In other words, it is the minimum thickness of all 60 measurements.

“Thickness Uniformity” is the number one minus the difference between “Maximum Thickness” minus “Minimum Thickness” divided by “Average Thickness,” then multiplied by 100. Again, by dividing the difference by the average thickness, the value is normalized to account for various nominal thicknesses of panels being evaluated.

“Thickness Uniformity Index” is “Thickness Uniformity” divided by “Thickness Covariance.”

TABLE 6
First Process (Data in mm units unless otherwise specified)
First Process

| Measurement | Sam- | Sam- | Sam- | Sam- | Sam- | |
|---|---|---|---|---|---|---|
| No. | ple 1 | ple 2 | ple 3 | ple 4 | ple 5 | |
| 1 | 0.879 | 0.780 | 1.029 | 0.942 | 0.801 | |
| 2 | 0.893 | 0.916 | 0.831 | 0.744 | 0.733 | |
| 3 | 0.992 | 0.902 | 0.965 | 0.848 | 0.914 | |
| 4 | 0.964 | 0.940 | 0.893 | 1.049 | 0.940 | |
| 5 | 0.841 | 0.862 | 0.856 | 0.923 | 1.052 | |
| 6 | 0.955 | 0.937 | 0.818 | 0.838 | 0.982 | |
| 7 | 0.806 | 0.852 | 0.781 | 0.820 | 0.923 | |
| 8 | 0.941 | 0.928 | 0.933 | 0.951 | 0.927 | |
| 9 | 0.906 | 0.918 | 0.876 | 0.994 | 0.944 | |
| 10 | 0.922 | 0.888 | 0.983 | 0.859 | 0.903 | |
| 11 | 0.897 | 0.885 | 0.900 | 1.096 | 0.931 | |
| 12 | 0.850 | 0.850 | 0.917 | 0.842 | 0.853 | |
| Average | 0.904 | 0.888 | 0.899 | 0.909 | 0.909 | 0.902 |
| Standard Deviation | 0.055 | 0.046 | 0.072 | 0.103 | 0.082 | 0.072 |
| Covariance | 6.1% | 5.2% | 8.0% | 11.3% | 9.1% | 8.0% |

TABLE 7
Improved Process (Data in mm units unless otherwise specified)
Improved Process

| Measurement | Sam- | Sam- | Sam- | Sam- | Sam- | |
|---|---|---|---|---|---|---|
| No. | ple 1 | ple 2 | ple 3 | ple 4 | ple 5 | |
| 1 | 1.001 | 1.062 | 0.987 | 0.953 | 0.999 | |
| 2 | 1.002 | 1.017 | 1.012 | 1.074 | 0.941 | |
| 3 | 1.081 | 1.013 | 0.933 | 0.881 | 0.861 | |
| 4 | 1.041 | 0.993 | 0.937 | 0.908 | 0.921 | |
| 5 | 1.063 | 1.026 | 1.043 | 0.980 | 1.041 | |
| 6 | 1.043 | 1.130 | 0.899 | 0.940 | 0.959 | |
| 7 | 1.074 | 0.979 | 0.912 | 1.019 | 0.953 | |
| 8 | 0.954 | 1.044 | 1.033 | 1.027 | 0.902 | |
| 9 | 1.001 | 1.082 | 1.027 | 1.054 | 0.953 | |
| 10 | 0.919 | 0.923 | 1.026 | 0.931 | 0.988 | |
| 11 | 0.987 | 0.892 | 1.034 | 1.053 | 1.039 | |
| 12 | 1.034 | 1.015 | 0.926 | 1.022 | 1.050 | |
| Average | 1.017 | 1.015 | 0.981 | 0.987 | 0.967 | 0.993 |
| Standard Deviation | 0.049 | 0.065 | 0.055 | 0.063 | 0.059 | 0.060 |
| Covariance | 4.8% | 6.4% | 5.6% | 6.4% | 6.1% | 6.0% |

TABLE 8
Comparison of First Process and Improved Process
SUMMARY COMPARISON

| | | | Improved |
|---|---|---|---|
| Property | Units | First Process | Process |
| Average Thickness | mm | 0.902 | 0.993 |
| Thickness Standard Deviation | mm | 0.072 | 0.060 |
| Thickness Covariance | % | 8.0 | 6.0 |
| Maximum Thickness | mm | 1.096 | 1.130 |
| Minimum Thickness | mm | 0.733 | 0.861 |
| Thickness Range | mm | 0.363 | 0.269 |
| Thickness Uniformity | % | 60 | 73 |
| Thickness Uniformity Index | NA | 7.5 | 12.2 |

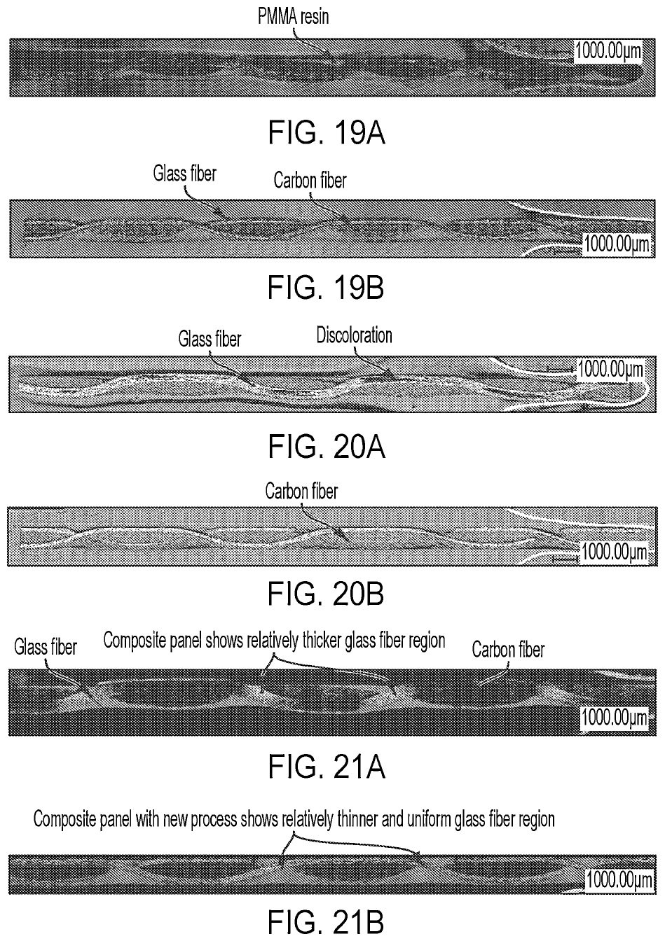

Referring generally to FIGS. 19A-22B, the figures depict scanning electron microscopy images of a randomly selected cross-section obtained from sample 3 (FIG. 24) of a panel produced in accordance with the first process and of a panel produced in accordance with the improved process. The images depict a basket weave fabric with glass fibers in the warp direction and carbon fibers in the weft direction was use as substrate. Also illustrated in these images is one layer of polyester non-woven material (one side of the basket weave fabric) that was combined with the PMMA resin to produce composite panels.

The present invention improves upon the uniformity of thickness. For example, as seen in FIG. 19A (100× magnification in color), FIG. 20A (100× magnification), and FIG. 21A (200× magnification in color), the new process produces panels characterized by a reduced thickness measurement of the glass fiber region, in contrast to the fiber glass region of the panel produced by the first process, as seen in FIG. 19B (100× magnification in color), FIG. 20B (100× magnification) and FIG. 21B (200× magnification in color).

Referring specifically to FIG. 21A-B for example, Scanning Electron Microscopy (SEM) images of composite panel cross-sections are shown (the panels being produced according to the first process in FIG. 21A and the improved process in FIG. 21B). A basket weave fabric, with glass fibers in the warp direction and carbon fibers in the weft direction, was used as the substrate. This substrate, along with one layer of polyester non-woven material on one side of the basket weave fabric, was combined with PMMA resin to produce a composite panel using both processes (the first process and the improved process) for comparison. As a result, the composite panel in FIG. 21A, produced according to the first process, shows a relatively thicker glass fiber region. In contrast, the composite panel in FIG. 21B, produced according to the improved process, shows a relatively shows a relatively thinner and more uniform glass fiber region.

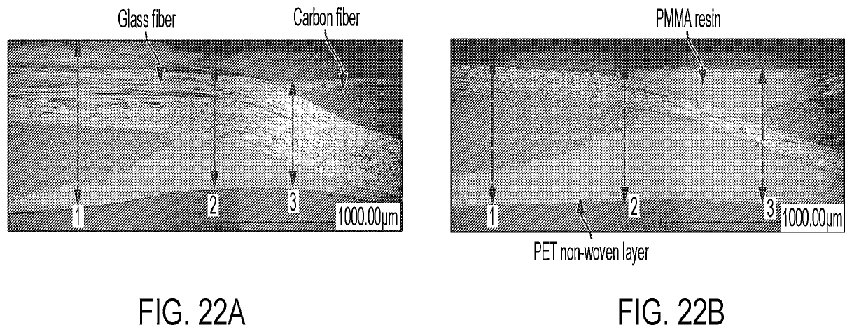

Further, as seen more clearly in FIG. 22A (200× magnification in color) and FIG. 22B (200× magnification in color), the variability in thickness measurements of the composite panel produced in accordance with the present invention is reduced. The SEM image shows a randomly selected region from the composite panels shown in FIG. 21A-B, taken from each of the two panels (the first and improved processes) with greater magnification. Different regions in the specimen cross-sections (labeled as 1, 2, and 3) highlight the variability in the thickness of composite produced using the first process (on the left or FIG. 22A). In contrast, composite produced by the improved process (on the right or FIG. 22B) shows much more consistent thickness in similar regions highlighted in the image on the right—this qualitative consistency in thickness is also demonstrated quantitatively at a macro-level through thickness data measurements described above.

Looking at FIG. 22A, for example, one can visually appreciate that the thickness measurements of a panel produced by the first process, as taken along lines 1, 2, and 3, vary relative to one another. Looking at FIG. 22B, however, one can visually appreciate that the thickness measurements of a panel produced by the improved process, as taken along similarly situated lines 1, 2, and 3, depict less variability relative to that illustrated in FIG. 22A. As noted above, this qualitative observation is consistent with the quantitative data depicted by Tables 6-8 above.

### Resin Content

An experiment was performed to compare the content of resin on the composite panels produced in accordance with a first process and with the improved process. The first process, as described above, includes steps of wrapping, stacking, and cooling of pre-pressed sections of material for subsequent unwrapping and pressing.

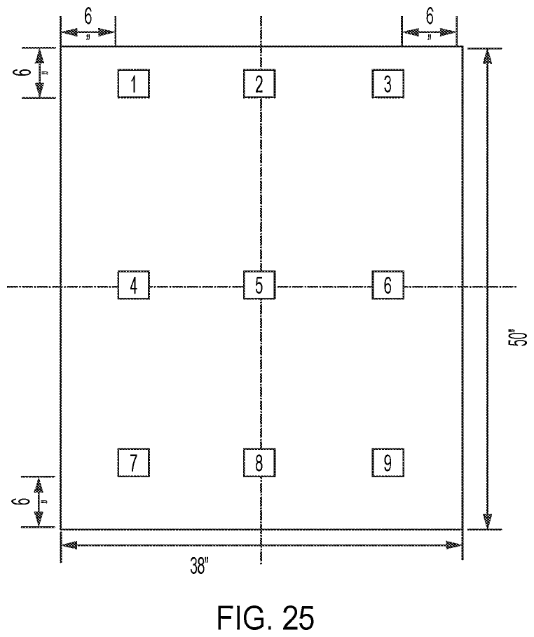

The experiment was performed according to the following conditions. Referring to FIG. 25, nine samples were obtained from different locations on a composite panel, having an L of 50 inches and a W of 38 inches that was produced in accordance with the first process described above with reference to FIG. 23. Similarly, nine samples were obtained from different locations on a composite panel, having an L of 50 inches and a W of 38 inches that was produced in accordance with the present invention. The samples were 1 inch×1 inch and were obtained in accordance with the placements (1-9) illustrated in FIG. 25. To determine resin content measurements of each sample obtained from composite panels produced in accordance with each of the first and improved processes, the listed steps were followed.
1. The muffle furnace used for the burn off test (to determine resin content) is the Thermo Scientific Thermolyne 1300 model. It was set at 550° C.
2. An empty crucible is weighed and the weight is recorded.
3. Test specimens (9) are obtained at various locations on a composite panel. Locations for sample collection are illustrated in FIG. 25. Sample location #5 is in the approximate center of the panel. Sample locations #1-4 and 6-9 are 6 inches away from each of the long and short edges of the panel.
3. Test specimen of size 1″ by 1″ is placed in the crucible and the new weight is recorded.
4. Crucible and sample are placed in the furnace for 60 minutes.
5. The crucible is removed from the oven and the new weight of the crucible and its contents is recorded.
6. Resin content is calculated according to the equation: (Sample weight before−Sample weight after)×100/Sample weight before)

The mean resin content (measured wt %), standard deviation, and coefficient of variance of each sample was calculated. Compared to the first process, the present invention provided an improvement in terms of the content of applied resin on the composite panels. For example, as seen in Tables 9-11 below, the present invention results in an improved resin content uniformity based on the low level of covariance indicated by the new process. In Table 11 below, the following properties are reported and are defined as follows:

“Average Resin Content” is the average resin content of all resin content measurements; specifically, it is the average of resin contents for Samples 1-9. In other words, it is the average resin content based on all 9 resin content measurements.

“Resin Content Standard Deviation” is the standard deviation of all resin content measurements; specifically, it is the standard deviation of resin contents for Samples 1-9. In other words, it is the standard deviation based on all 9 resin content measurements.

“Resin Content Covariance” is the Resin Content Standard Deviation (defined above) divided by the Average Resin Content (defined above) times 100. By dividing the resin content standard deviation by the average resin content, the standard deviation value is normalized to account for various nominal resin contents of panels being evaluated.

“Maximum Resin Content” is the maximum resin content from Samples 1-9. In other words, it is the maximum resin content of all 9 measurements.

“Minimum Resin Content” is the minimum resin content from Samples 1-9. In other words, it is the minimum resin content of all 9 measurements.

“Resin Content Uniformity” is the number one minus the difference between “Maximum Resin Content” minus “Minimum Resin Content” divided by “Average Resin Content,” then multiplied by 100. Again, by dividing the difference by the average resin content, the value is normalized to account for various nominal resin contents of panels being evaluated.

“Resin Content Uniformity Index” is “Resin Content Uniformity” divided by “Resin Content Covariance.”

TABLE 9
First Process

| | | Before burn-off | After burn-off | |
|---|---|---|---|---|
| Sample | Cup wt | Cup + sample | Cup + sample | % resin |
| location | (gm) | wt (gm) | wt (gm) | content |
| 1 | 33.2 | 34.1 | 33.8 | 32.6 |
| 2 | 39.7 | 40.6 | 40.3 | 33.6 |
| 3 | 33.2 | 34.1 | 33.8 | 32.7 |
| 4 | 25.0 | 26.0 | 25.6 | 34.2 |
| 5 | 39.7 | 40.6 | 40.3 | 37.5 |
| 6 | 25.0 | 25.9 | 25.6 | 34.4 |
| 7 | 39.7 | 40.6 | 40.3 | 33.7 |
| 8 | 25.0 | 26.0 | 25.6 | 35.1 |
| 9 | 33.2 | 34.1 | 33.8 | 31.3 |

TABLE 10
Improved Process

| | | Before burn-off | After burn-off | |
|---|---|---|---|---|
| Sample | Cup wt | Cup + sample | Cup + sample | % resin |
| location | (gm) | wt (gm) | wt (gm) | content |
| 1 | 39.7 | 40.8 | 40.4 | 37.5 |
| 2 | 33.2 | 34.4 | 34.0 | 35.5 |
| 3 | 33.2 | 34.4 | 33.9 | 39.5 |
| 4 | 39.7 | 40.8 | 40.4 | 36.4 |
| 5 | 33.2 | 34.3 | 33.9 | 36.3 |
| 6 | 39.7 | 40.9 | 40.4 | 38.0 |
| 7 | 25.0 | 26.2 | 25.8 | 37.9 |
| 8 | 25.0 | 26.2 | 25.7 | 37.1 |
| 9 | 25.0 | 26.1 | 25.7 | 39.3 |

TABLE 11
Comparison of First Process and Improved Process
SUMMARY COMPARISON

| | | | Improved |
|---|---|---|---|
| Property | Units | First Process | Process |
| Average Resin Content | wt. % | 33.9 | 37.5 |
| Resin Content Standard deviation | wt. % | 1.7 | 1.3 |
| Resin Content Covariance | % | 5.2 | 3.6 |
| Maximum Resin Content | wt. % | 37.5 | 39.5 |
| Minimum Resin Content | wt. % | 31.3 | 35.5 |
| Range | wt. % | 6.1 | 4.0 |
| Resin Content Uniformity | % | 82 | 89 |
| Resin Content Uniformity Index | NA | 15.8 | 24.7 |

The foregoing properties relating to thickness uniformity and resin content uniformity are enhanced by the improved process. It is believed that these enhanced properties result from the conditions and steps of the improved process and their impact on the uniformity of the thickness of produced panels and the uniformity of the resin content of the produced panel. For example, and without being tethered to any particular theory, when resin viscosity is very high, e.g. measuring few 10 thousand cps, viscous forces are dominant. The dominant viscous forces limit the resin's ability to achieve optimum wet-out/impregnation of a given substrate material. This is especially true when the resin is allowed to impregnate the substrate at ambient/normal atmospheric pressure conditions. In the case of reactive systems, the problem is further exacerbated because the resin-coated substrate is stored at refrigerated/freezer conditions in order to increase the materials' shelf life and prevent a premature initiation of the cross-linking reaction.

Because the degree of wet-out/impregnation is a function of the resin viscosity and the substrate permeability, lower viscosity and higher permeability would be desired for maximum substrate wet-out/impregnation by the resin system. This relationship is based on the concepts of flow through porous media as explained by Darcy's law.

When the substrate impregnated with highly viscous resin is introduced in a press of the first process for composite laminate/part production, the resin is pushed out/flashed along the perimeter of the substrate. It is desired for the substrate to be ideally or optimally impregnated by the resin, but the chances of a relatively excessive amount of resin being squeezed out along the perimeter is higher with the use of a highly viscous resin. Further, the resin can be pushed and evened out in the central region of the substrate, but depending on the size of the substrate, and for relatively larger substrates, the resin could be highly concentrated in the center portion of the material system relative to the peripheral regions in the first process described above. This can result in a resin content gradient in the composite panel with the central or core region having a higher amount of resin as compared to the peripheral region where the resin is pushed out.

Accordingly, the material systems with higher viscosity resins can have drawbacks in some circumstances, including that the composites produced by the first process can result in greater variability in certain composite panel properties such as thickness and fiber/resin content. Variability in these properties can further have implications on variability in material, mechanical, and potentially other properties.

In contrast, the improved process contemplates use of resin with reduced viscosity (as low as ˜100 cps for example), such that capillarity forces are more dominant than viscosity forces. As a result, the resin wets-out/impregnates the substrate much faster and the resin is evenly driven by concepts of capillarity and wicking effects. When the resin-coated substrate is introduced in a press for composite laminate/part production, the amount of resin pushed out/flashed along the perimeter of the substrate is relatively lower because it is easier for the low viscosity resin to pack and move within the substrate to fill in any voids or regions that might be resin starved. Accordingly, the materials system with lower viscosity resin has the advantage of producing composite panels with more uniform thickness and more uniform resin/fiber content, and hence, may be expected to have better consistency in mechanical and other properties.

As illustrated in FIGS. 20A-20B, the present invention improves upon the uniformity of resin content. For example, as seen in FIG. 20A (100× magnification), the first process produces panels having regions with darker discoloration, relative to the panels produced by the improved process, as seen in FIG. 20B (100× magnification). The reduction in discoloration is indicative of uniformity in fiber-resin distribution because discoloration suggests a higher amount of variability in uniformity of fiber-resin distribution as compared to regions without the discoloration. This qualitative observation is consistent with the quantitative data depicted by Tables 9-11 above.

In addition to the viscosity of the resin used in the process, the improved process differs from the first process in other ways that are believed to impact the uniformity of thickness and/or uniformity of resin content. For example, the improved process embodiment illustrated herein utilizes spray application of resin onto a substrate, a resin-substrate combination interposed or “sandwiched” between two elongated film layers to form a continuous or semi-continuous die, an enclosure within which the resin is applied in a controlled way, a press positioned to press the resin-substrate combination through the film layers, the continuous or semi-continuous nature of the process that advances the resin-substrate combination from a resin-application station to a press and to the film removal.

It is believed that these features of the improved process, individually or in combination, contribute to improved uniformity of the produced panel. This uniformity is especially beneficial with respect to thickness and resin content.

Thickness

Improved uniformity of the thickness of the produced panels can be quantified in terms of Thickness Covariance, Thickness Uniformity, and Thickness Uniformity Index. Specifically, a reduction in Thickness Covariance is desired as is an increase in Thickness Uniformity and an increase in Thickness Uniformity Index.

The Thickness Uniformity Index of the reinforced composite product is preferably 8 or greater, or more preferably 10 or greater. The Thickness Covariance of the reinforced composite product is preferably 7% or less, or more preferably 6% or less. The Thickness Uniformity of the reinforced composite product is preferably 61% or greater, or more preferably 70% or greater. The reinforced composite product can have at least one of a Thickness Uniformity Index of 8 or greater, a Thickness Covariance of 7% or less, and/or a Thickness Uniformity of 61% or greater, or any combination of these.

Resin Content

Improved uniformity of the resin content of the produced panels can be quantified in terms of Resin Content Covariance, Resin Content Uniformity, and Resin Content Uniformity Index. Specifically, a reduction in Resin Content Covariance is desired as is an increase in Resin Content Uniformity and an increase in Resin Content Uniformity Index.

The Resin Content Uniformity Index of the reinforced composite product is preferably 16 or greater, or more preferably 20 or greater. The Resin Content Covariance of the reinforced composite product is preferably 5% or less, or more preferably 4% or less. The Resin Content Uniformity of the reinforced composite product is preferably 83% or greater, or more preferably 85% or greater. The reinforced composite product can have at least one of a Resin Content Uniformity Index of 16 or greater, a Resin Content Covariance of 5% or less, and/or a Resin Content Uniformity of 83% or greater, or any combination of these.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

1. A system for producing composite products including a substrate and a resin integrated with the substrate, the system comprising:
a press located between an upstream end portion of the system, which is configured to receive the substrate into the system, and a downstream end portion of the system, which is configured to deliver the composite products from the system;
a lower film supply located at the upstream end portion of the system and configured to introduce a lower film into the system and in a downstream direction toward the press;
a substrate supply located at the upstream end portion of the system and configured to introduce the substrate into the system, onto the lower film, and in the downstream direction toward the press;
a resin dispenser located upstream of the press and downstream of the substrate supply and configured to apply the resin to the substrate to form a resin-substrate combination;
an upper film supply located downstream of the resin dispenser and configured to introduce an upper film into the system, in the downstream direction toward the press, and onto the resin-substrate combination; and
a film removal station located at a downstream end portion of the system and configured to remove the lower film and the upper film from the resin-substrate combination;
the press being located downstream of the upper film supply and upstream of the film removal station, the press being positioned to apply pressure to the resin-substrate combination through the upper film and the lower film when the resin-substrate combination is co-located with the press.

2. The system for producing composite products according to claim 1, further comprising a heater configured to heat the resin-substrate combination to an elevated temperature above an ambient temperature, the elevated temperature being selected to accelerate curing or polymerization of the resin of the resin-substrate combination.

3-10. (canceled)

11. The system for producing composite products according to claim 1, the system being configured to receive substrate cut using a CNC or nesting operation.

12. The system for producing composite products according to claim 1, the substrate having a thickness not exceeding about 5 mm.

13. The system for producing composite products according to claim 1, the resin dispenser being configured to apply resin including a thermoplastic polymer or a thermoset polymer having a viscosity up to 5000 cps.

14. The system for producing composite products according to claim 13, the resin dispenser being configured to apply resin including a thermoplastic polymer or a thermoset polymer having a viscosity up to 500 cps.

15. The system for producing composite products according to claim 13, the resin dispenser being configured to apply resin including a thermoplastic polymer or a thermoset polymer having a viscosity up to 250 cps.

16. The system for producing composite products according to claim 13, the resin dispenser being configured to apply resin including a thermoplastic polymer or a thermoset polymer having a viscosity up to 100 cps.

17. The system for producing composite products according to claim 1, the resin dispenser being configured to apply resin including a polymer, a monomer, or a combination thereof that can be cross-linked for polymerization.

18. The system for producing composite products according to claim 1, the resin dispenser being configured to apply resin including one or more of a color package, a reaction initiator, a reaction inhibitor, an impact modifier, a flame retardant, a lubricant, a light stabilizer, an electrically or thermally conductive additive, and an anti-oxidant.

19. The system for producing composite products according to claim 1, the resin dispenser being configured to apply resin including a thermoplastic polymer that is dissolvable into solvent to change viscosity.

20. (canceled)

21. The system for producing composite products according to claim 1, the resin dispenser being configured to apply resin by spraying.

22-27. (canceled)

28. The system for producing composite products according to claim 1, the resin dispenser including a reservoir for containing the resin and a spray nozzle coupled to receive resin from the reservoir and for spraying the resin onto the substrate.

29. The system for producing composite products according to claim 28, the resin dispenser being configured to spray the resin onto the substrate in a pattern.

30. The system for producing composite products according to claim 28, wherein the spray nozzle is configured for spraying a formulation of the resin onto the substrate in a predetermined pattern.

31-39. (canceled)

40. The system for producing composite products according to claim 1, the film removal station including a winder configured to roll the lower film and the upper film onto respective rolls of the lower film and the upper film.

41. The system for producing composite products according to claim 1, the press including a top platen and a bottom platen mounted for movement relative to one another such that:
when the top platen and the bottom platen are moved toward one another by movement of at least one of the top platen and the bottom platen, the press is configured to close on the lower film and the upper film with the resin-substrate combination between the lower film and the upper film until a seal is formed to enclose at least a portion of the lower film, the upper film, and the resin-substrate combination; and
when the top platen and the bottom platen are moved away from one another by movement of at least one of the top platen and the bottom platen, the press opens and the seal is released.

42. (canceled)

43. The system for producing composite products according to claim 1, further comprising a pulling station configured to pull the lower film and the upper film, with the resin-substrate combination interposed between the lower film and the upper film, in a downstream direction.

44. The system for producing composite products according to claim 43, the pulling station being located downstream of the press.

45. The system for producing composite products according to claim 43, the pulling station being located upstream of the film removal station.

46. (canceled)

47. The system for producing composite products according to claim 1, further comprising at least one wet-out station configured to promote integration of the resin into the substrate in the resin-substrate combination.

48. The system for producing composite products according to claim 47, the at least one wet-out station being located downstream of the resin dispenser.

49. The system for producing composite products according to claim 47, the at least one wet-out station being located upstream of the press.

50-60. (canceled)

61. The system for producing composite products according to claim 1, wherein:
the lower film is configured for movement relative to the press in a downstream direction extending from an upstream end of the press toward a downstream end of the press, the lower film having an upper surface positioned to support a combination of the substrate and the resin, the lower film having a continuous length selected to extend beyond the upstream end of the press in an upstream direction and beyond the downstream end of the press in the downstream direction;
the upper film is configured for movement relative to the press in the downstream direction extending from the upstream end of the press toward the downstream end of the press, the upper film having a lower surface positioned to contact the combination of the substrate and the resin, the upper film also having a continuous length selected to extend beyond the upstream end of the press in the upstream direction and beyond the downstream end of the press in the downstream direction; and
a seal is formed by contact between the upper surface of the lower film and the lower surface of the upper film, the seal being positioned to at least partially surround the substrate, the seal extending along portions of the continuous lengths of the lower film and the upper film, and the seal extending lateral to the continuous lengths of the lower film and the upper film;
the lower film, the upper film, and the seal together defining a die interior configured to enclose the combination of the substrate and the resin.

62. The system for producing composite products according to claim 61, the seal forming a perimeter to at least partially surround the substrate, the perimeter having a shape generally corresponding to a shape of the substrate, thereby reducing the amount of resin squeezed out of the substrate upon application of pressure.

63. The system for producing composite products according to claim 61, the lower film including polyethylene terephthalate or polycarbonate.

64-65. (canceled)

66. The system for producing composite products according to claim 61, the upper film including polyethylene terephthalate or polycarbonate.

67-69. (canceled)

70. A process for producing composite products including a substrate and a resin integrated with the substrate, the process comprising:
supplying a lower film to introduce the lower film in a downstream direction; supplying a substrate to introduce the substrate in the downstream direction and onto the lower film;
dispensing a resin to apply the resin to the substrate to form a resin-substrate combination;
supplying an upper film to introduce an upper film onto the resin-substrate combination;
applying pressure to the resin-substrate combination through the upper film and the lower film; and
removing the lower film and the upper film from the resin-substrate combination.

71. The process according to claim 70, further comprising heating the resin-substrate combination to an elevated temperature above an ambient temperature, the elevated temperature being selected to accelerate curing or polymerization of the resin of the resin-substrate combination.

72. The process according to claim 70, further comprising sealing a perimeter of the lower film and the upper film to at least partially surround the substrate, the perimeter having a shape generally corresponding to a shape of the substrate, thereby reducing the amount of resin squeezed out of the substrate upon application of pressure.

73-74. (canceled)

75. The system for producing composite products according to claim 1, further configured for capturing Volatile Organic Compound (VOCs) during the production of the composite products including the substrate and the resin integrated with the substrate, the system further comprising:
an enclosure into which the substrate can be introduced when the enclosure is open, the enclosure being configured to contain VOCs emitted in the enclosure when the enclosure is closed;
a filter coupled to receive VOCs from the enclosure of the resin dispenser; and
an exhaust configured to reduce pressure within the enclosure and positioned to purge the VOCs from the enclosure and into the filter, the exhaust being operable when the enclosure is open to allow the substrate to enter the enclosure and to allow the resin-substrate combination to exit the enclosure.

76. The system for producing composite products according to claim 75, the resin dispenser including a spray nozzle and the enclosure including a spray box having an upstream gate that opens to allow the substrate to enter the enclosure and a downstream gate that opens to allow the resin-substrate combination to exit the enclosure.

77. The system for producing composite products according to claim 7, further comprising an upper film supply located upstream of the downstream gate of the enclosure and configured to introduce an upper film into the system, in a downstream direction toward the downstream gate of the enclosure, and onto the resin-substrate combination, the upper film providing a barrier against the escape of VOCs from the resin-substrate combination as the resin-substrate combination exits the downstream gate of the enclosure.

78. The system for producing composite products according to claim 77, the enclosure of the resin dispenser including an upper film gate positioned to allow entry of the upper film into the enclosure.

79. The system for producing composite products according to claim 78, the upper film gate being positioned in a top portion of the enclosure to allow passage of the upper film toward an upper surface of the substrate.

80-84. (canceled)

85. A process for capturing VOCs while producing composite products including a substrate and a resin integrated with the substrate to form a resin-substrate combination, the process comprising:
opening an upstream gate of an enclosure;
actuating an exhaust to reduce pressure within the enclosure when the upstream gate of the enclosure is open;
receiving the substrate in the enclosure through the upstream gate of the enclosure;
closing the upstream gate of the enclosure;
applying the resin to the substrate to form the resin-substrate combination in the enclosure; and
exhausting VOCs from the enclosure and into a filter.

86-143. (canceled)

144. The system for producing composite products according to claim 19, wherein the resin comprises methyl methacrylate (MMA), poly-methyl methacrylate (PMMA), or a combination thereof.
